(19) United States
(12) Patent Application Publication
(10) Pub. No.: US 2013/0114740 A1
(43) Pub. Date: May 9, 2013

(54) IMAGE CODING METHOD, IMAGE CODING APPARATUS, IMAGE DECODING METHOD, IMAGE DECODING APPARATUS, AND STORAGE MEDIUM

(71) Applicant: CANON KABUSHIKI KAISHA, Tokyo (JP)

(72) Inventor: Masaaki Kobayashi, Kawasaki-shi (JP)

(73) Assignee: CANON KABUSHIKI KAISHA, Tokyo (JP)

(21) Appl. No.: 13/669,295

(22) Filed: Nov. 5, 2012

(30) Foreign Application Priority Data
Nov. 7, 2011 (JP) 2011-243935

(51) Int. Cl. H04N 7/26

(52) U.S. Cl. 375/240.25; 375/240.01; 375/E07.171; 375/E07.027

(57) ABSTRACT

An image coding apparatus includes a determination unit configured to determine, from a progressive image and format information indicating characteristics of the progressive image, whether an input progressive image is an image that is deinterlaced from an interlace image, a deinterlace information extraction unit configured to extract information indicating a deinterlace method from the format information when the input progressive image is a deinterlaced image, a first coding unit configured to encode a result of the determination unit, a second coding unit configured to encode a result of the deinterlace information extraction unit, an image coding unit configured to encode an input progressive image, and an output unit configured to integrate and output a result of the first coding unit, a result of the second coding unit, and a result of the image coding unit.

### BACKGROUND OF THE INVENTION

1. Field of the Invention

One disclosed aspect of the embodiments relates to an image coding apparatus, an image coding method, an image decoding apparatus, an image decoding method, and a storage medium configured to encode and decode an image by using a motion vector.

2. Description of the Related Art

In the digital broadcasting standard ARIB-STD-B32, a broadcasting method for an interlace video image is specified, and now a large number of interlace video images are actually recorded and broadcasted. A progressive format and an interlace format are employed as video image formats. In the progressive format, a frame image is configured of a single image. For example, when a frame rate of the video image is 30/1.001 fps, the frame image is recorded, transmitted, and displayed at every 1.001/30 sec.

On the other hand, in the interlace format, the frame image is configured of two different types of field images as a pair. One of the two field images is a top field image that is configured of a zeroth line, a second line, a fourth line, and so on (hereinafter, referred to as “top field lines”) of the frame image in a horizontal direction.

The other one of the two field images is a bottom field image which is configured of a first line, a third line, a fifth line, and so on (hereinafter, referred to as “bottom field lines”) of the frame image in a horizontal direction. Therefore, vertical resolution of the field image is a half of the resolution of the frame image.

Further, capturing timings (display timings) of the top field image and the bottom field image are shifted with each other. For example, in a case where a frame rate of an interlace video image is 30/1.001 fps, there is a time lag of 1.001/60 sec between the field images because two fields are equal to one frame (2 fields=1 frame).

At present, there are many opportunities for viewing video images using computers. Usually, display monitors of the computers do not support the input and display of the interlace video image. Therefore, in order to view the interlace video image, the interlace video image has to be converted into a progressive video image before the video image is output to the display monitor.

In addition, in order to view the video image or perform image processing on the video image, an image size thereof may be converted. However, the interlace video image has a unique line structure, and therefore, the interlace video image requires complicated processing for converting the image size thereof in comparison with the conversion of the image size of the progressive video image. Therefore, in many cases, the video image may be recorded efficiently if the video image that is captured and recorded in the interlace format is converted and encoded into the progressive format in advance.

When the video image that is recorded in the interlace format is saved in a progressive format, deinterlace processing needs to be performed to convert the interlace video image into a progressive image. A BOB method and a WEAVE method are known as general categories of deinterlace methods.

In the BOB method, a single frame image is generated by interpolating missing lines with top and bottom lines of a field image. A frame rate of the generated image is twice as much as the frame rate of the original interlace video image. However, there is a problem in that the actual resolution in the vertical direction thereof becomes a half of the resolution of the frame image.

In the WEAVE method, a single frame image is generated by interleaving a top field image and a bottom field image of the same frame line-by-line. With this method, the vertical resolution for a motionless scene is high. However, there is a problem in that a noise (so-called “combing noise”) may be easily generated in a region with motion.

Further, deinterlace processing which combines the BOB method and the WEAVE method in an adaptive manner depending on each region may be employed. However, it is problematic in that the processing load thereof is heavy because the processing is performed adaptively. Therefore, an optimum deinterlace method is selected based on the characteristics and the use case of the image because there are advantages and disadvantages in the above-described deinterlace methods.

In addition, in order to broadcast, record, and operate a video image, the data amount of the video image needs to be reduced by encoding the video image. MPEG-2 (ISO/IEC 13818-2:2000 Information technology-Generic coding of moving pictures and associated audio information: Video), H.264 (ISO/IEC 14496-10: 2004 Information technology—Coding of audio-visual objects—Part 10: Advanced Video Coding), and Motion JPEG 2000(ISO-15444-3/ITU-T Rec.802) are provided as coding methods for the video images.

MPEG-2 is a coding method which is employed for the above-described digital broadcasting in the interlace format. H.264 is a coding method having coding efficiency higher than that of MPEG-2. Therefore, in these days, H.264 has been often used to record video images on a memory card, a hard disk, and an optical medium.

Motion JPEG 2000 is a coding method suitable for editing moving images. Although MPEG-2 and H.264 support coding of both of the progressive format and the interlace format, Motion JPEG 2000 only supports coding of the progressive format.

A progressive image that is generated from a field image by interpolating lines into the field image by the BOB method may be reconverted into the field image by thinning out the interpolated lines from the progressive image.

There is provided a coding apparatus which receives a field image, converts the input field image into a progressive image, and encodes the progressive image to generate an image stream. Further, there is also provided a decoding apparatus which decodes the image stream to generate the progressive image, and reconverts the progressive image into the field image.

When the image stream generated by the coding apparatus is transmitted from the coding apparatus to the decoding apparatus, the decoding apparatus which serves as a transmission destination cannot identify the lines that have been interpolated thereto. Therefore, there is a problem in that the decoding apparatus may thin out the line which is present in the original field image input by the coding apparatus, thus the field image may not be regenerated correctly.

### SUMMARY OF THE INVENTION

One disclosed aspect of the embodiments is directed to an image coding method, an image coding apparatus, an image decoding method, and an image decoding apparatus capable of regenerating a field image that is equivalent to a field image input by the image coding apparatus of a transmission source, by the image decoding apparatus of a transmission destination.

According to an aspect of the embodiments, an image coding apparatus includes a determination unit configured to determine, from a progressive image and format information indicating characteristics of the progressive image, whether an input progressive image is an image that is deinterlaced from an interlace image, a deinterlace information extraction unit configured to extract information indicating a deinterlace method from the format information when the input progressive image is a deinterlaced image, a first coding unit configured to encode a result of the determination unit, a second coding unit configured to encode a result of the deinterlace information extraction unit, an image coding unit configured to encode an input progressive image, and an output unit configured to integrate and output a result of the first coding unit, a result of the second coding unit, and a result of the image coding unit.

According to an embodiment, the decoding apparatus refers to line interpolated information, thins out the interpolated lines correctly, and removes an effect such as a quantization error caused by the coding processing. Through the processing, the field image that is equivalent to the field image input by the coding apparatus of a transmission source may be regenerated by the decoding apparatus of a transmission destination.

Further features and aspects of the disclosure will become apparent from the following detailed description of exemplary embodiments with reference to the attached drawings. One disclosed feature of the embodiments may be described as a process which is usually depicted as a flowchart, a flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed. A process may correspond to a method, a program, a procedure, a method of manufacturing or fabrication, etc. One embodiment may be described by a schematic drawing depicting a physical structure. It is understood that the schematic drawing illustrates the basic concept and may not be scaled or depict the structure in exact proportions.

### BRIEF DESCRIPTION OF THE DRAWINGS

The accompanying drawings, which are incorporated in and constitute a part of the specification, illustrate exemplary embodiments, features, and aspects of the disclosure and, together with the description, serve to explain the principles of the disclosure.

FIG. 1 is a block diagram illustrating a coding apparatus according to a first exemplary embodiment.

FIG. 2 is a block diagram illustrating a stream generation unit of the coding apparatus according to the first exemplary embodiment.

FIG. 3 is a block diagram illustrating a decoding apparatus according to a second exemplary embodiment.

FIG. 4 is a block diagram of a stream decoding unit of the decoding apparatus according to the second exemplary embodiment.

FIG. 5A is a diagram illustrating a processing example of interpolating a bottom field line of a Y-plane. FIG. 5B is a diagram illustrating a processing example of interpolating a top field line of the Y-plane.

FIG. 6A is a table illustrating an example of syntax for format information. FIG. 6B is a table illustrating values of a code “original_frame_type” of the format information. FIG. 6C is a table illustrating a code “interlace method” of the format information.

FIG. 7A is a diagram illustrating a combination example of a format information bit sequence and an image stream.

FIG. 7B is a diagram illustrating a first modification of the combination example of the format information bit sequence and the image stream.

FIG. 8 is a block diagram illustrating a configuration example of an archive system including the coding apparatus and the decoding apparatus.

FIG. 9 is a block diagram illustrating a hardware configuration for executing a program.

FIG. 10 is a flowchart illustrating a flow of executing deinterlace processing and coding processing by a field interleaving method.

FIG. 11 is a flowchart illustrating a flow of generating and integrating the image stream and the format information bit sequence.

FIG. 12 is a flowchart illustrating a flow of a deinterlace information coding subroutine.

FIG. 13 is a flowchart illustrating a flow of image decoding processing and interlace processing.

FIG. 14 is a flowchart illustrating a flow of an image stream decoding subroutine.

FIG. 15 is a flowchart illustrating a flow of a deinterlace information decoding subroutine.

FIG. 16 is a flowchart illustrating a flow of executing deinterlace processing and coding processing by a field compositing method.

FIG. 17 is a flowchart illustrating a flow of executing deinterlace processing and coding processing.

### DESCRIPTION OF THE EMBODIMENTS

Various exemplary embodiments, features, and aspects of the disclosure will be described in detail below with reference to the drawings.

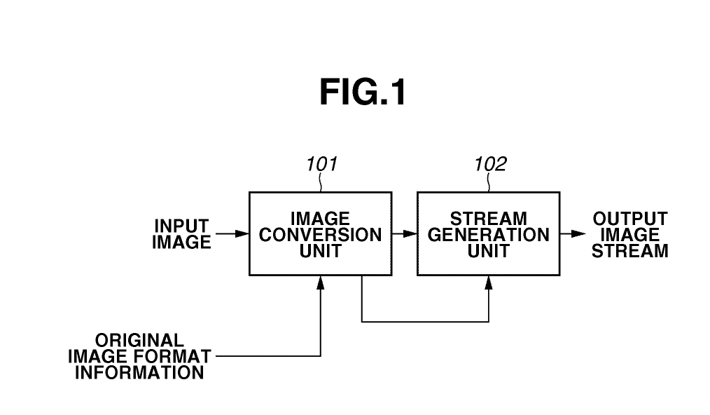

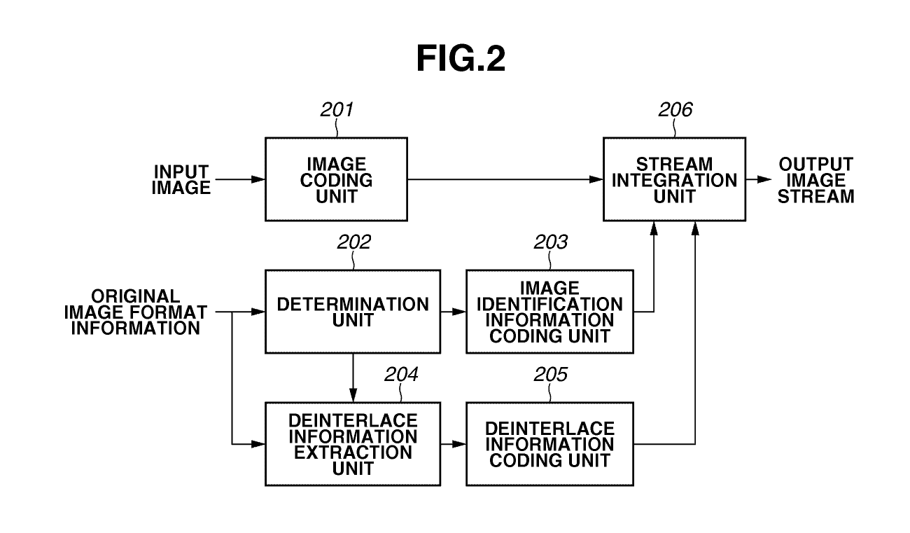

In the present exemplary embodiment, a coding apparatus which receives an interlace image in field image units to generate a progressive image from the interlace image, or which receives a progressive image to encode the progressive image will be described with reference to FIGS. 1 and 2.

The input image according to the present exemplary embodiment is described as either an interlace image in YUV420 frame sequential format, or a progressive image in YUV420 frame sequential format. The frame sequential format is a storage format where pixel values are stored for each plane. Each of the planes is a group of pixel values for each color component. Therefore, the image in YUV 420 frame sequential format is configured of independent planes of a Y-plane, a U-plane, and a V-plane.

FIG. 1 is a block diagram illustrating details of the coding apparatus according to the present exemplary embodiment. An image conversion unit 101 performs deinterlace processing. A stream generation unit 102 performs image coding processing. Hereinbelow, details of operations performed by the coding apparatus will be described.

In addition, a processing target is a video image which is configured of a plurality of continuous images collected. However, in the coding apparatus, the description will be given based on the condition where the images included in the video image are processed in a sequential manner. Further, in the present exemplary embodiment, the image input to the image conversion unit 101 of the coding apparatus is called as an original image.

The original image and original image format information are input into the image conversion unit 101. The original image format information is configured of image identification information and field identification information. The image identification information identifies whether the original image is an interlace image or a progressive image.

The field identification information indicates whether the input field image is a top field image or a bottom field image when the original image is an interlace image.

When the image identification information indicates the progressive image, the image conversion unit 101 outputs the original image and the format information to the stream generation unit 102. The format information is configured of the image identification information and deinterlace information.

In a case where the image identification information indicates the interlace image, the image conversion unit 101 converts the original image into a progressive image, and outputs the progressive image and the format information to the stream generation unit 102. The deinterlace processing method for converting an original image into a progressive image and the deinterlace information will be described later.

In the present exemplary embodiment, the image conversion unit 101 may perform both of the deinterlace methods, the BOB method and the WEAVE method. Therefore, a user sets one of the deinterlace methods in advance to the image conversion unit 101.

In the present exemplary embodiment, the deinterlace method where a frame image is generated with respect to a single field image through deinterlace processing performed by, for example, the BOB method is referred to as a “field interleaving” method. On the other hand, the deinterlace method where a single frame image is combined with two field images through deinterlace processing performed by, for example, the WEAVE method is referred to as a “field compositing” method.

Hereinbelow, operations of the deinterlace processing using the BOB method performed by the image conversion unit 101 according to the present exemplary embodiment will be described.

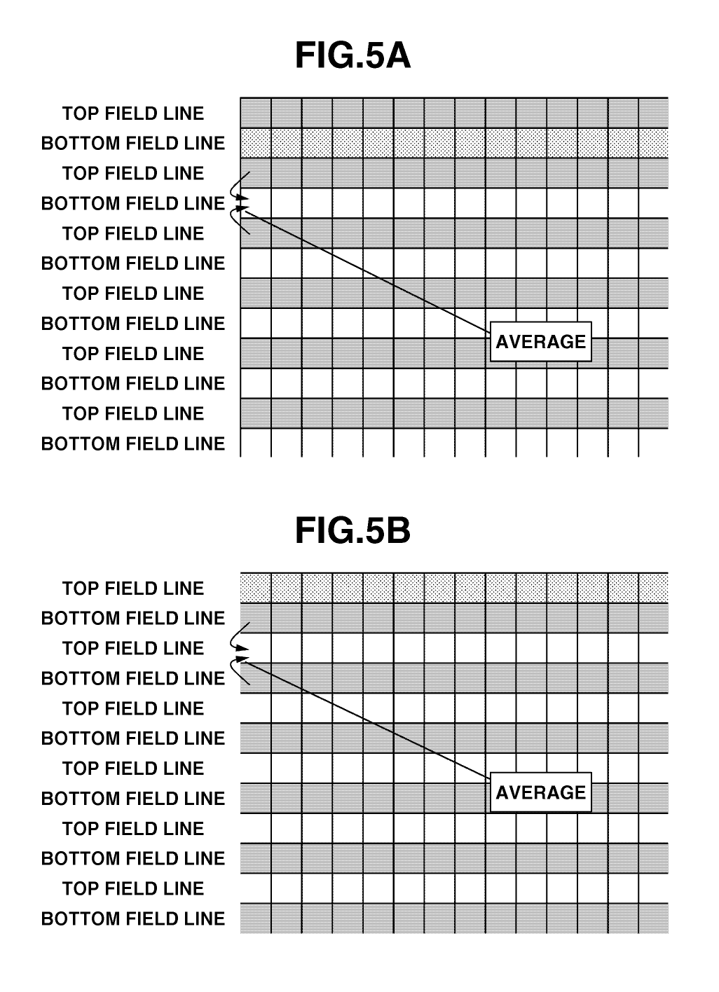

FIG. 5A is a diagram illustrating a processing example of interpolating a bottom field line of the Y-plane. FIG. 5B is a diagram illustrating a processing example of interpolating a top field line of the Y-plane.

In FIGS. 5A and 5B, dark-shaded portions indicate the presence of pixels of the frame, light-shaded portions indicate that the pixels of the frame are interpolated, and white portions indicate that the pixels of the frame are missing.

In a case where the field identification information of the input field image indicates the top field image, as illustrated in FIG. 5A, the image conversion unit 101 calculates an average of the pixel values of the pixels in the upper and lower top field lines for each pixel, and generates missing pixels of the bottom field lines.

In a case where the field identification information of the input field image indicates the bottom field image, as illustrated in FIG. 5B, the image conversion unit 101 calculates an average of the pixel values of the pixels in the upper and lower bottom field lines for each pixel, and generates missing pixels of the top field lines. With this processing, the image conversion unit 101 generates a progressive image from the field image.

In a similar manner, the image conversion unit 101 performs the above processing on the U-plane and the V-plane. When the image conversion unit 101 outputs the generated progressive image, the image conversion unit 101 outputs the deinterlace information and the image identification information to the stream generation unit 102. The deinterlace information is configured of deinterlace method information, line interpolated information, and field synthesis information.

The deinterlace method information indicates whether the deinterlace method is the “field interleaving” method or the “field compositing” method. The line interpolated information identifies whether the interpolated line is a top field line or a bottom field line.

The field compositing information, which is described below, is provided exclusive of the line interpolated information. In a case where the image conversion unit 101 performs deinterlace processing by the BOB method, the deinterlace method information indicates “field interleaving”, and the deinterlace information only includes the deinterlace method information and the line interpolated information.

After performing deinterlace processing by the BOB method according to the present exemplary embodiment, the frame rate thereof is twice as large as an input frame rate. For example, if the input frame rate is 30 fps (60 fields per second), the frame rate of the generated progressive image is 60 fps.

Hereinbelow, operations of the deinterlace processing by the WEAVE method according to the present exemplary embodiment will be described. The image conversion unit 101 receives two field images consecutively. Then, the image conversion unit 101 generates a frame image from the field images. In the frame image, lines of the top field image are disposed on top field lines, whereas lines of the bottom field image are disposed on bottom field lines thereof, respectively.

At the same time, the image conversion unit 101 outputs the deinterlace information and the image identification information to the stream generation unit 102. In a case where the image conversion unit 101 performs deinterlace processing by the WEAVE method, the deinterlace method information indicates “field compositing”, and the deinterlace information includes the deinterlace method information and the field compositing information.

Herein, the field compositing information will be described. In the present exemplary embodiment, display timings of the top field image and the bottom field image are shifted by 1/60 sec, for example. However, when the field images are combined, the time of the top field image and the time of the bottom field image are treated same. As a result, the temporal back-and-forth relationship between the top field image and the bottom field image may not be identified.

The field compositing information is information to identify whether the time of the top field image precedes the time of the bottom field image. When the combined field image is separated again, the top field image and the bottom field image may be separated in a correct temporal order by referring to the field compositing information.

Even if the image conversion unit 101 performs deinterlace processing by the WEAVE method according to the present exemplary embodiment, the frame rate thereof is not changed. In other words, for the two field images input to the image conversion unit 101, the image conversion unit 101 outputs a single progressive image to the stream generation unit 102.

The stream generation unit 102 receives the progressive image and the format information input from the image conversion unit 101. Then, the stream generation unit 102 generates an image stream.

FIG. 2 is a block diagram illustrating details of an internal configuration of the stream generation unit 102. The stream generation unit 102 includes an image coding unit 201, a determination unit 202, an image identification information coding unit 203, a deinterlace information extraction unit 204, a deinterlace information coding unit 205, and a stream integration unit 206.

The image coding unit 201 encodes the input progressive image by the H.264 method to generate an image stream, and outputs the image stream to the stream integration unit 206. In the present exemplary embodiment, the H.264 method is employed as the coding method. However, the coding method is not limited thereto, and the other coding method such as MPEG-2 may be employed. Especially, the coding may be performed by the coding method such as Motion JPEG 2000 where the interlace coding method is not specified.

When the format information is input to the determination unit 202, the determination unit 202 extracts the image identification information from the format information. Then, the determination unit 202 outputs the image identification information to the image identification information coding unit 203 and the deinterlace information extraction unit 204.

The image identification information coding unit 203 encodes the image identification information and generates the image identification information code. Then, the image identification information coding unit 203 outputs the image identification information code to the stream integration unit 206. A method for encoding the image identification information will be described later.

When the image identification information input into the deinterlace information extraction unit 204 indicates the interlace image, the deinterlace information extraction unit 204 receives the format information. Then, the deinterlace information extraction unit 204 extracts the deinterlace information from the format information, and outputs the extracted deinterlace information to the deinterlace information coding unit 205.

The deinterlace information coding unit 205 encodes the deinterlace information and generates a deinterlace information code. Then, the deinterlace information coding unit 205 outputs the deinterlace information code to the stream integration unit 206. A method for encoding the deinterlace information will be described below. Further, in a case where the image identification information indicates the progressive image, the deinterlace information is not input to the deinterlace information coding unit 205. Therefore, the deinterlace information coding unit 205 will not perform the coding processing.

The stream integration unit 206 combines the image identification information code and the deinterlace information code and generates a format information bit sequence. Further, the stream integration unit 206 integrates the format information bit sequence to an image stream. Thereafter, the stream integration unit 206 outputs the integrated image stream to the outside thereof. However, when the image identification information indicates the progressive image, the deinterlace information code is not included in the format information bit sequence because the deinterlace information code is not generated.

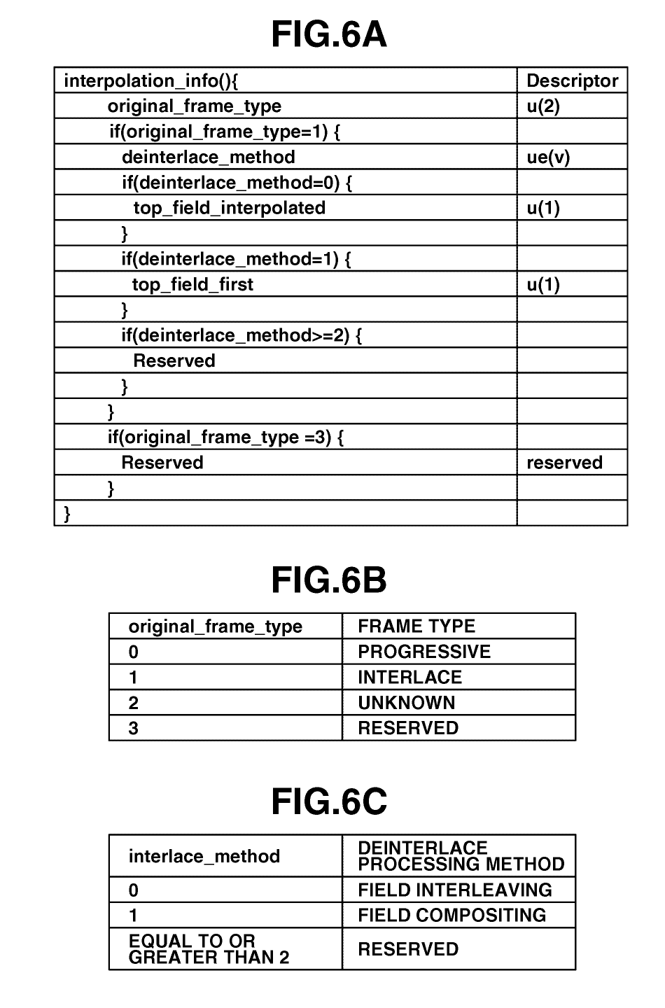

In the present exemplary embodiment, an external storage is exemplified as an external output destination. The details thereof will be described below. In the present exemplary embodiment, the image identification information code and the deinterlace information code are collectively referred to as a format information bit sequence. The format information bit sequence having configuration according to the syntax illustrated in FIGS. 6A through 6C will be described.

The format information bit sequence according to the present exemplary embodiment will be described below with reference to FIGS. 6A through 6C. FIG. 6A is a diagram illustrating an example of syntax which indicates a structure of the format information bit sequence. A notation system for expressing the syntax is compliant with the notation system specified in the H.264 standards.

In FIG. 6A, the first column indicates a code name and a conditional statement for inserting a code, and the second column indicates a coding method of the code. In the second column in FIG. 6A, u(n) and ue(v) represent an n-bit positive integer and a variable-length positive integer respectively, and an n-bit fixed length code and a Golomb code are generated as corresponding codes thereof.

In FIG. 6A, for example, “original_frame_type” is expressed as a 2-bit code which takes a value from 0 to 3. Each of the generated codes is combined with each other, and a bit sequence is generated. Further, the conditional statement for inserting the code is expressed as follows:

if (conditional expression){
code 1
}
This conditional statement indicates that the code 1 is generated when the conditional expression is “true”, and the generated code is inserted into the bit sequence. In addition, the row denoted as “Reserved” indicate that an undefined-length code may be inserted thereto when the format information bit sequence is functionally expanded in the future.

A code “original_frame_type” in the format information bit sequence is a code to identify whether the original image is “progressive image”, “interlace image”, or “unknown”. The “original_frame_type” is a code name of the image identification information code used in the syntax, and the values thereof are illustrated in FIG. 6B.

FIG. 6B is a table illustrating relationships between values of the code “original_frame_type” and corresponding image formats. A value “3” is allocated as a reserved code. This enables the format information bit sequence to be functionally expanded in the future.

A code “deinterlace_method” in the format information bit sequence is a code to identify whether the deinterlace processing is performed by the “field interleaving” method or the “field compositing” method. The “deinterlace_method” is a code name of the deinterlace method code used in the syntax, and values thereof are illustrated in FIG. 6C.

FIG. 6C is a table illustrating relationships between values of the code “deinterlace_method” and corresponding deinterlace methods. Values equal to or greater than 2 are allocated as reserved codes. This enables the format information bit sequence to be functionally expanded in the future.

A code “top_field_interpolated” in the format information bit sequence is a code name of the line interpolated information code used in the syntax. The line interpolated information code is generated by encoding the line interpolated information. When the value of the code “top_field_interpolated” is 1, a coding-target image of the image stream to which the format information bit sequence is integrated is generated by interpolating top field lines.

When the value of the code “top field interpolated” is 0, the coding-target image of the image stream to which the format information bit sequence is integrated is generated by interpolating bottom field lines.

A code “top_field_first” in the format information bit sequence is a code name of the filed synthesis information code used in the syntax. The field compositing information code is generated by encoding the field compositing information. When the value of the code “top_field_first” is 1, a top field image of the coding-target image temporally precedes a bottom field image. When the value of the code “top_field_first” is 0, the top field image of the coding-target image temporally succeeds the bottom field image thereof.

Hereinbelow, settings of specific values for the codes in the syntax of the format information bit sequence according to the present exemplary embodiment will be described.

The image identification information coding unit 203 generates the code “original_frame_type”. When the image identification information indicates the progressive image, 0 is set as a value of “original_frame_type”, and when the image identification information indicates the interlace image, 1 is set as a value thereof. The code “original_frame_type” is generated as a 2-bit code. In a case where an image in an unknown format may be input thereto, “3” may be set as a corresponding value of “original_frame_type”.

In addition, the deinterlace information coding unit 205 generates codes “deinterlace_method”, “top_field_interpolated”, and “top_field_first”, which serve as the deinterlace information codes. However, as illustrated in FIG. 6A, the codes “top_field_interpolated” and “top_field_first” are generated exclusively.

Further, as described above, when the image identification information does not indicate the interlace image, the deinterlace information coding unit 205 does not generate these codes.

When the deinterlace method information indicates “field interleaving”, 0 is set as a value of the code “deinterlace_method”, and when the deinterlace method information indicates “field compositing”, 1 is set as a value thereof. The code “deinterlace_method” is generated as a variable-length Golomb code.

The deinterlace information coding unit 205 generates the code “top_field_interpolated” only when the deinterlace processing is performed by the “field interleaving” method. When the line interpolated information indicates that the top field lines are interpolated, 1 is set as a value of the code “top_field_interpolated”, and when the line interpolated information indicates that the bottom field lines are interpolated, 0 is set as a value thereof. The code “top_field_interpolated” is generated as a 1-bit code.

The deinterlace information coding unit 205 generates the code “top_field_first” only when the deinterlace processing is performed by the “field compositing method”. When the field compositing information indicates that the “top field image temporally precedes the bottom field image”, 1 is set as a value of the code “top_field_first”, and when the top field image does not temporally precede the bottom field image, 0 is set as a value thereof. The code “top_field_first” is generated as a 1-bit code.

Hereinbelow, an output operation of data performed by the stream integration unit 206 will be described. When the stream integration unit 206 outputs the data such as the format information bit sequence and the image stream to the outside, the stream integration unit 206 applies a start code to each data. Then, the stream integration unit 206 combines the data with the data output immediately before that data.

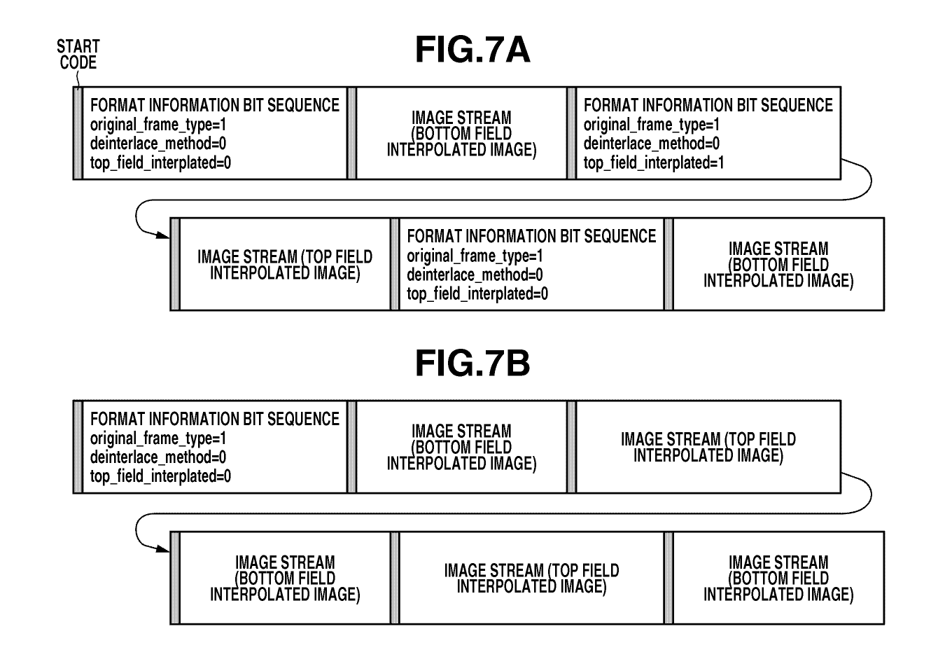

FIG. 7A is a diagram illustrating an example of the image stream to which the format information bit sequence is integrated. The format information bit sequence is arranged immediately before the corresponding image stream, and a plurality of image streams is combined with each other. As described above, in the example illustrated in FIG. 7A, in order to separate the format information bit sequence and the image stream, the stream integration unit 206 applies the start code which identifies a boundary of each data to a leading portion of the data.

The thick lines in FIG. 7A indicate the start codes. The start code is a byte data having a specific data pattern. In H.264, the start code is a three-byte data configured of values of {0, 0, 1}. Because the byte pattern {0, 0, 1} is not present in the image stream of H.264, the decoding apparatus may identify the boundary between the format information bit sequence and the image stream by detecting the start code from the plurality of image streams combined with each other.

This enables the decoding apparatus to acquire the image stream and corresponding format information bit sequence as a single unit of image data.

The coding apparatus according to the present exemplary embodiment converts the interlace image into the progressive image prior to the coding processing. Therefore, the image stream generated by the coding apparatus is advantageous in that the decoding apparatus which does not support interlace decoding may perform decoding processing thereof.

In addition, because the interlace image is encoded and saved as the progressive image, the image size of the decoded image may be converted with ease. Further, the decoded image may be output to a display monitor which does not support the interlace image without performing deinterlace processing thereon. However, in some cases, the decoded progressive image may be reconverted and used as an interlace format image. For example, there may be a following case.

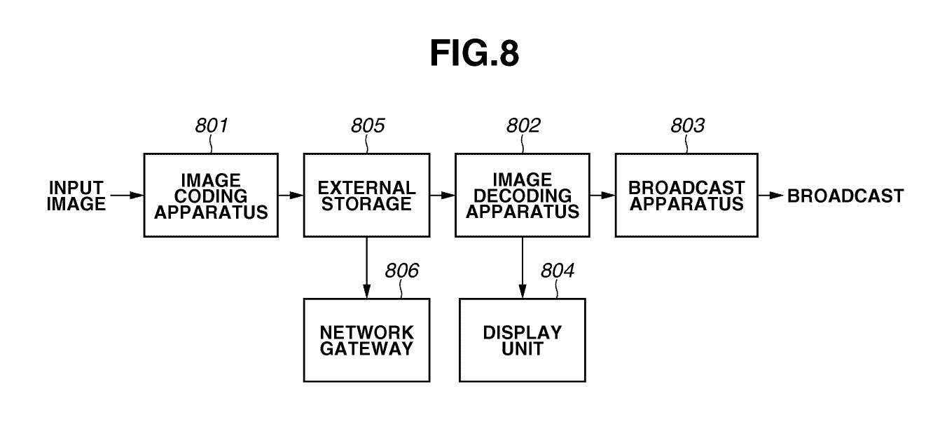

FIG. 8 is a block diagram illustrating a configuration example of an archive system which includes a coding apparatus and a decoding apparatus. The archive system includes a coding apparatus 801 according to the present exemplary embodiment, a decoding apparatus 802, a broadcast apparatus 803, a display unit 804, an external storage 805, and a network gateway 806.

Hereinbelow, an operation of the archive system will be described. The coding apparatus 801 converts an input interlace image into a progressive image, encodes the progressive image by the H.264 coding method, generates an image stream, and stores the image stream into the external storage 805. In this manner, a plurality of image streams is stored in the external storage 805 for each video image.

The network gateway 806 distributes the stored image stream through a network. The decoding apparatus 802 decodes the image stream stored in the external storage 805, converts the decoded progressive image into an interlace image, and outputs the interlace image to the broadcast apparatus 803.

The broadcast apparatus 803 re-encodes the interlace image by the MPEG-2 coding method, and broadcasts the encoded image stream in the interlace format defined by the standards. Further, the decoding apparatus 802 is configured to outputs the progressive image, so that the progressive image is displayed on the display unit 804.

A video image for network distribution is often reproduced by a computer and displayed on a display monitor connected thereto which does not support the interlace image. When this situation is taken into account, the above-described configuration is considerably advantageous because the image recorded as a progressive image may be distributed directly.

On the other hand, the decoding apparatus 802 is configured to be capable of outputting both the progressive image and the interlace image according to the purpose of use. Accordingly, the archive system according to the present exemplary embodiment is configured as a very rational system. In the archive system according to the present exemplary embodiment, the coding processing performed by the H.264 method and the MPEG-2 method is described. However, the coding methods are not limited thereto.

In the present exemplary embodiment, the syntax including the information regarding the deinterlace processing method is defined. Then, the format information bit sequence generated based on the syntax is integrated to the image stream.

Then, the image stream to which the format information bit sequence is integrated is transmitted to the decoding apparatus 802. This enables the decoding apparatus 802 to receive the information regarding the deinterlace processing method. In a case where the decoding apparatus 802 outputs the interlace image, the decoding apparatus 802 may reconvert the progressive image that has been decoded based on the information regarding the deinterlace processing method into the interlace format.

In the present exemplary embodiment, the format information bit sequence generated according to the syntax structure in FIG. 6A is described. However, the format information bit sequence is not limited thereto. Any format information bit sequence may be applicable as long as the format information bit sequence includes a code regarding the deinterlace processing method.

For example, a limiting condition, in which the format information bit sequence is integrated to the image stream only when the original image is the interlace image, may be provided. With this condition, it is possible to identify whether the original image is an interlace image even if the format information bit sequence does not include the image identification information code.

Further, in the coding processing and the decoding processing, the deinterlace method may be limited to the field interleaving method only. With this limitation, only the line interpolated information may be transmitted as the information relating to the deinterlace method.

In addition, the coding methods for the respective information codes are not limited to the fixed-length coding and the variable-length Golomb coding specified by the syntax. Further, there is no limitation on the sequence thereof, and an exclusive definition defined by the conditional statement is not required if reduction of the code amount is not taken into account.

The deinterlace processing according to the present exemplary embodiment is not limited to the above-described processing. For example, the deinterlace processing which interpolates the lines by referring the other field image, or the deinterlace processing which employs a motion compensation method, may be employed as well.

Regardless of the change in pixel values of the lines which are originally present in the original image, the deinterlace method is regarded as the “field interleaving” method as long as the frame image is generated by setting a single field image as a reference. Further, even if a combing noise reduction filter is applied thereto, the deinterlace method is regarded as the “field compositing” method as long as the frame image is generated from two field images.

In the present exemplary embodiment, when the deinterlace processing is performed by the “field interleaving” method, the line interpolated information is encoded and integrated to the image stream. However, the present exemplary embodiment is not limited thereto. Instead, the field identification information of the input field image may be encoded and integrated to the image stream.

The interpolated lines may be identified if the field image is identified. Accordingly, the same effect may be obtained when either one of the line interpolated information or the field identification information is encoded and integrated to the image stream.

In the present exemplary embodiment, the configuration in which each of the format information bit sequence and the image stream is stored as independent data that is separated by the start code, has been described. However, the configuration is not limited thereto.

For example, the configuration may be such that the syntax illustrated in FIG. 6A is inserted and included as apart of the syntax for the header information of the image stream. In this case, the coding method may be a newly-employed coding method, or a newly-expanded existing coding method. Further, in the present exemplary embodiment, the configuration in which the format information bit sequence is generated and integrated to each image stream is described. However, the configuration is not limited thereto. As illustrated in FIG. 7B, the configuration may be such that the format information bit sequence is only generated for the image stream encoded from the first frame, and the format information bit sequence is only integrated to the image stream of the first frame.

FIG. 7B is a diagram illustrating a first modification where the format information bit sequence is only integrated to the image stream of the first frame. In a similar manner, the format information bit sequence may be generated and integrated to the image stream at intervals of a certain number of images. Further, the configuration may be such that a bit length corresponding to the format information bit sequence or a bit length corresponding to the image stream is inserted instead of the start code, thereby enabling the boundary position of the data thereof to be identified.

In addition, in a case where a plurality of image streams is output as a single file, an index which represents a position of a format information bit sequence and a position of an image stream within the file, may be added thereto. In any of the above described configurations, the boundary between the image stream and the format information bit sequence may be identified.

In the present exemplary embodiment, an image in YUV420 format is described as an example of the color-difference format of the input image. However, the color-difference format is not limited thereto. As an input format, an image in either YUV 422 format or YUV444 format may be input and encoded.

In the present exemplary embodiment, processing in which the interlace image is input and processed in field units is described. However, the processing is not limited thereto. The interlace image may be input in frame units where two fields are combined to form one frame. In a case where the interlace image is input in frame units, the same processing described in the present exemplary embodiment may be performed by providing a function in which the frame is separated into two fields, and each of the fields is processed in a sequential manner.

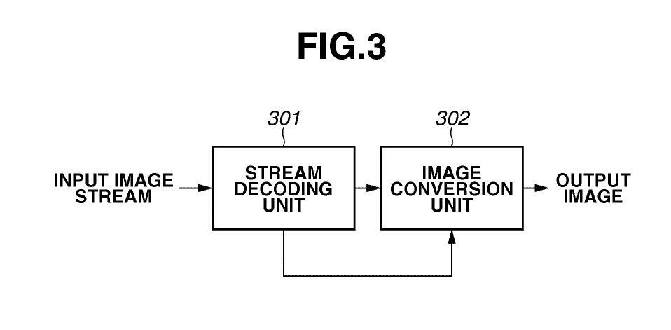

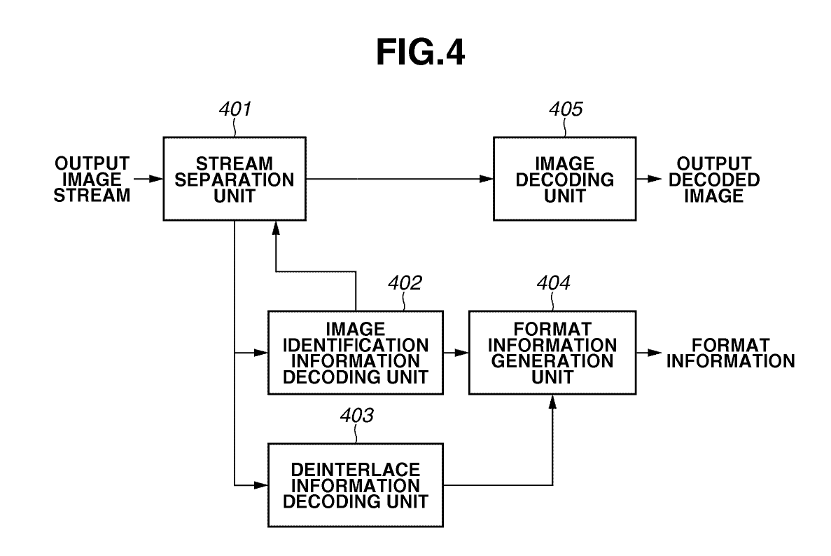

In a second exemplary embodiment, the decoding apparatus 802 which decodes an image stream and outputs an interlace image will be described with reference to FIGS. 3 and 4. The image stream is generated by the coding apparatus 801 described in the first exemplary embodiment, and a format information bit sequence is integrated to the image stream.

In the present exemplary embodiment, the decoding apparatus 802 converts the image decoded as a progressive image in YUV 420 frame sequential format into an interlace image in YUV420 frame sequential format. Thereafter, the decoding apparatus 802 outputs the converted interlace image in YUV420 frame sequential format. However, the color-difference format depends on the image stream, and the value thereof is not limited thereto. In addition, words and terms used in the present exemplary embodiment are similar to those described in the first exemplary embodiment unless otherwise specified.

FIG. 3 is a block diagram illustrating the decoding apparatus 802 according to the present exemplary embodiment. The decoding apparatus 802 includes a stream decoding unit 301 and an image conversion unit 302.

When the image stream to which the format information bit sequence is integrated is input to the stream decoding unit 301, the stream decoding unit 301 decodes the input image stream and generates a progressive image and format information. Thereafter, the stream decoding unit 301 outputs the progressive image and the format information to the image conversion unit 302.

As illustrated in FIG. 7A, the image stream to which the format information bit sequence is integrated is stored in an external storage in such a manner that a plurality of the image streams is combined with each other. Then, the stream decoding unit 301 detects the start code and acquires the image stream for a single image where the format information bit sequence is integrated thereto.

Further, the format information bit sequence configured of the syntax illustrated in FIG. 6A will be described. The decoding apparatus 802 decodes and reads the codes which are encoded as a fixed-length code and a Golomb code by the coding apparatus 801 as the fixed-length code and the Golomb code respectively.

Further, the decoding apparatus 802 acquires the code which is generated by the coding apparatus 801 according to the conditional statement illustrated in FIG. 6A, and decodes the acquired code according to the conditional statement. The syntax structure for the format information bit sequence is not limited to the syntax structure illustrated in FIGS. 6A through 6C, and any syntax may be employed as long as the structure thereof is the same as that employed in the coding apparatus 801. The details of internal operations performed by the stream decoding unit 301 will be described below.

The image conversion unit 302 refers to the format information, and generates an interlace image from the input progressive image. Then, the image conversion unit 302 outputs the generated interlace image to the outside thereof. Details of operations performed by the image conversion unit 302 will be described below.

FIG. 4 is a block diagram illustrating details of an internal configuration of the stream decoding unit 301 illustrated in FIG. 3. The stream decoding unit 301 includes a stream separation unit 401, an image identification information decoding unit 402, a deinterlace information decoding unit 403, a format information generation unit 404, and an image decoding unit 405.

The stream separation unit 401 separates the image identification information code and the deinterlace information code from the input image stream to which the format information bit sequence is integrated. Then, the stream separation unit 401 outputs the image identification information code to the image identification information decoding unit 402, and outputs the image stream to the image decoding unit 405. Further, in a case where the separated image identification information code indicates the interlace image, the stream separation unit 401 outputs the deinterlace information code to the deinterlace information decoding unit 403.

The image decoding unit 405 decodes the image stream by the H.264 method, and outputs the decoded progressive image to the outside thereof. In the present exemplary embodiment, H.264 is employed as a decoding method. However, the decoding method is not limited thereto, and other decoding methods such as MPEG-2 and Motion JPEG 2000 may be employed as long as the method is the same as that of the coding method employed by the coding apparatus 801 according to the first exemplary embodiment.

The image identification information decoding unit 402 decodes the image identification information code, and generates the image identification information. Then, the image identification information decoding unit 402 outputs the image identification information to the format information generation unit 404 and the stream separation unit 401. In the present exemplary embodiment, when a decode value of the code “original_frame_type” is 0, the image identification information indicates the progressive image, and when the decode value of the code “original_frame_type” is 1, the image identification information indicates the interlace image.

The deinterlace information decoding unit 403 decodes the deinterlace information code, and generates the deinterlace information. Then, the deinterlace information decoding unit 403 outputs the deinterlace information to the format information generation unit 404.

As described in the first exemplary embodiment, the deinterlace information is configured of the deinterlace method information, the line interpolated information, and the field compositing information. The code names thereof used in the syntax illustrated in FIGS. 6A through 6C are “deinterlace_method”, “top_field_interpolated”, and “top_field_first”, respectively.

In the present exemplary embodiment, when the decode value of the code “deinterlace_method” is 0, the deinterlace method information of the deinterlace information indicates “field interleaving”, whereas the deinterlace method information indicates “field compositing” when the decode value thereof is 1. When the decode value of the code “top_field_interpolated” is 0, the line interpolated information of the deinterlace information indicates that the bottom field lines are interpolated, and when the decode value thereof is 1, the line interpolated information indicates that the top field lines are interpolated.

When the decode value of the code “top_field_first” is 1, the field compositing information of the deinterlace information indicates that “the top field image temporally precedes the bottom field image”, and when the decode value thereof is 0, the field compositing information of the deinterlace information indicates that “the top field image temporally succeeds the bottom field image”.

The code “top_field_interpolated” is decoded only when the decode value of the code “deinterlace_method” is 0, whereas the code “top_field_first” is decoded only when the decode value thereof is 1.

The format information generation unit 404 generates the format information from the deinterlace information and the image identification information.

Hereinbelow, the details of the processing performed by the image conversion unit 302 will be described. When the image identification information indicates the interlace image, the image conversion unit 302 performs the following operations. When the deinterlace method information indicates “field interleaving”, the image conversion unit 302 performs interlace processing according to the line interpolated information of the format information. When the line interpolated information indicates that the top field lines are interpolated, the image conversion unit 302 thins out the top field lines from the decoded progressive image, and generates a field image.

When the line interpolated information indicates that the bottom field lines are interpolated, the image conversion unit 302 thins out the bottom field lines from the decoded progressive image, and generates a field image. The above-described processing is reversed processing of the deinterlace processing described with reference to FIGS. 5A and 5B, and thus the image conversion unit 302 thins out the pixels other than the pixels of the dark-shaded portions. This thinning out processing is performed on the Y-plane, the U-plane, and the V-plane, respectively.

Through the interlace processing, a video image with a half frame rate is generated. For example, if the frame rate of the decoded progressive video image is 60 fps, an interlace video image with the frame rate of 30 fps (60 field per second) is generated.

When the deinterlace method information indicates “field compositing”, the image conversion unit 302 separates the top field image and the bottom field image from the frame image. When the field compositing information indicates that “the top field image temporally precedes the bottom field image”, the image conversion unit 302 outputs the top field image to the outside thereof first. After that, the image conversion unit 302 outputs the bottom field image to the outside thereof.

When the field compositing information indicates that “the top field image temporally succeeds the bottom field image”, the image conversion unit 302 outputs the bottom field image to the outside thereof first. After that, the image conversion unit 302 outputs the top field image to the outside thereof. The above-described separation processing is performed on each of the Y-plane, the U-plane, and the V-plane.

Through the above-described interlace processing, if the frame rate of the decoded progressive video image is 30 fps, for example, an interlace video image with the frame rate of 30 fps (60 fields per second) is generated.

In a case where the image identification information indicates the progressive image, the image conversion unit 302 performs frame rate conversion according to the output frame rate. After that, the image conversion unit 302 generates a bottom field image from an even number frame by thinning out the top field lines, and generates a top field image from an odd number frame by thinning out the bottom field lines.

If the output frame rate is 30 fps and the frame rate of the decoded progressive image is 30 fps, for example, the image conversion unit 302 performs frame rate conversion processing, and generates an image with the frame rate of 60 fps. Then, the image conversion unit 302 performs line thinning-out processing and generates a field image. After that, the image conversion unit 302 generates an interlace image with the frame rate of 30 fps.

The output frame rate is set according to the input frame rate acceptable by the apparatus which outputs the image. In the present exemplary embodiment, the processing which generates the field image by thinning out the lines after performing the frame rate conversion processing, is described. However, the processing is not limited thereto, and the processing which generates two field images from a single progressive image without performing the frame rate conversion processing may be performed.

In a case where the decoding apparatus reconverts the progressive image that has been converted through the line interpolation processing into an interlace image, the decoding apparatus was not previously able to identify the interpolated lines, and therefore, it is difficult for the decoding apparatus to thin out the interpolated lines in a correct manner.

By employing the configuration according to the present exemplary embodiment, when the decoding apparatus 802 reconverts the progressive image to the interlace image, the decoding apparatus 802 refers to the line interpolated information and thins out the interpolated lines in a correct manner. Through this processing, the decoding apparatus 802 may generate the interlace image that holds the pixels of the original image.

Further, the decoding apparatus 802 may convert the decoded progressive image into the interlace image even in a case where not all the image streams stored in the external storage are integrated with the format bit sequences, as illustrated in FIG. 7B. In the example of FIG. 7B, the format information bit sequence is only integrated to an image stream of the first frame.

When the deinterlace method is “field interleaving”, the image conversion unit 302 refers to the line interpolated information to perform interlace processing on the first frame image. Then, the image conversion unit 302 shifts the thinning-out lines from the lines of the first frame image, and performs interlace processing on the next image which does not hold the line interpolated information. In this manner, the image conversion unit 302 performs the interlace processing by shifting the thinning-out lines alternately.

When the deinterlace method is “field compositing”, the image conversion unit 302 performs interlace processing by taking the field compositing information of the first frame and the field compositing information of the second and the subsequent frames as the same. In addition, even in a case where the format information bit sequence is integrated at intervals of a certain number of frames, the image conversion unit 302 may perform interlace processing in a same manner as in the case where the format information bit sequence is only integrated to the first frame by making the image stream to which the format information bit sequence is integrated as a reference point.

Further, in a case where the format information bit sequence is inserted to the image stream as apart of the header information thereof, the stream separation unit 401 may have a function of separating the format information bit sequence from the image stream. With this configuration, the image conversion unit 302 may perform other processing described in the present exemplary embodiment.

In the present exemplary embodiment, the decoding apparatus 802 which outputs the interlace image is described. However, the configuration may be such that the user freely selects and switches the type of output image between the progressive image and the interlace image.

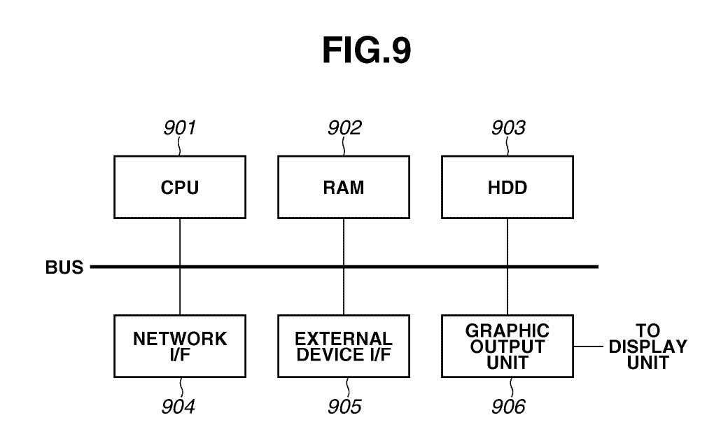

In a third exemplary embodiment, a coding method in which a progressive image is generated from an interlace image by receiving the interlace image, and a coding method in which a progressive image is encoded by receiving the progressive image will be described with reference to FIGS. 9, 10, 11, 12, and 17.

The interlace image is input in field image units. Further, words and terms used in the present exemplary embodiment are similar to those described in the first exemplary embodiment unless otherwise specified.

The input image in the present exemplary embodiment is described as either an interlace image in YUV420 frame sequential format, or a progressive image in YUV420 frame sequential format.

FIG. 9 is a block diagram illustrating a hardware configuration for executing a coding program including a cording method according to the present exemplary embodiment. The coding program according to the present exemplary embodiment is stored in a hard disk drive (hereinbelow, simply referred to as “HDD”) 903. When the coding program is activated, the coding program is loaded on a random access memory (RAM) 902. Then, a central processing unit (CPU) 901 performs coding processing by executing the following steps.

In the present exemplary embodiment, input image data is stored in the HDD 903, and the CPU 901 performs coding processing by acquiring the image from the HDD 903. Further, the coded image stream is stored in an external storage via an external device I/F 905.

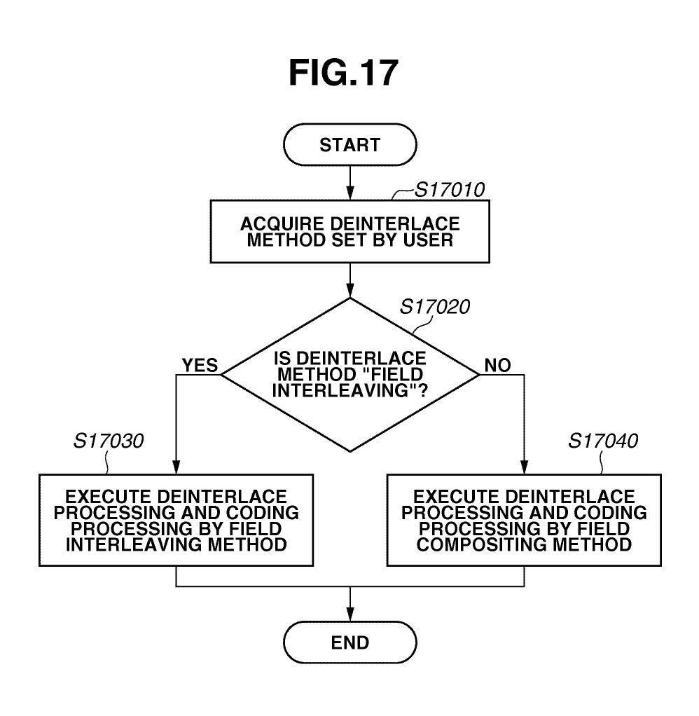

Processing of the coding method according to the present exemplary embodiment will be described below with reference to FIG. 17. FIG. 17 is a flowchart illustrating flows of executing deinterlace processing and coding processing. A processing target is a video image configured of a plurality of images collected in a sequential manner. A series of video images are encoded when the processing illustrated in FIG. 17 is performed in a consecutive manner. In addition, a method of deinterlace processing is specified by a user in advance when the coding program is executed.

In operation S17010, the CPU 901 acquires a deinterlace method set by the user. In operation S17020, the CPU 901 determines the deinterlace method set by the user. When the determination method set by the user is “field compositing” (NO in operation S17020), the processing proceeds to operation S17040. When the determination method set by the user is “field interleaving” (Yes in operation S17020) the processing proceeds to operation S17030.

In operation S17030, the CPU 901 performs deinterlace processing and coding processing by the field interleaving method. In the present exemplary embodiment, the CPU 901 executes a subroutine for performing deinterlace processing and coding processing by the field interleaving method. The details of the subroutine will be described below. After performing the processing in S17030, the CPU 901 ends the processing.

In operation S17040, the CPU 901 performs deinterlace processing and coding processing by the field compositing method. In the present exemplary embodiment, the CPU 901 executes a subroutine for performing deinterlace processing and coding processing by the field compositing method. The details of the subroutine will be described below. After performing the processing in S17040, the CPU 901 ends the processing.

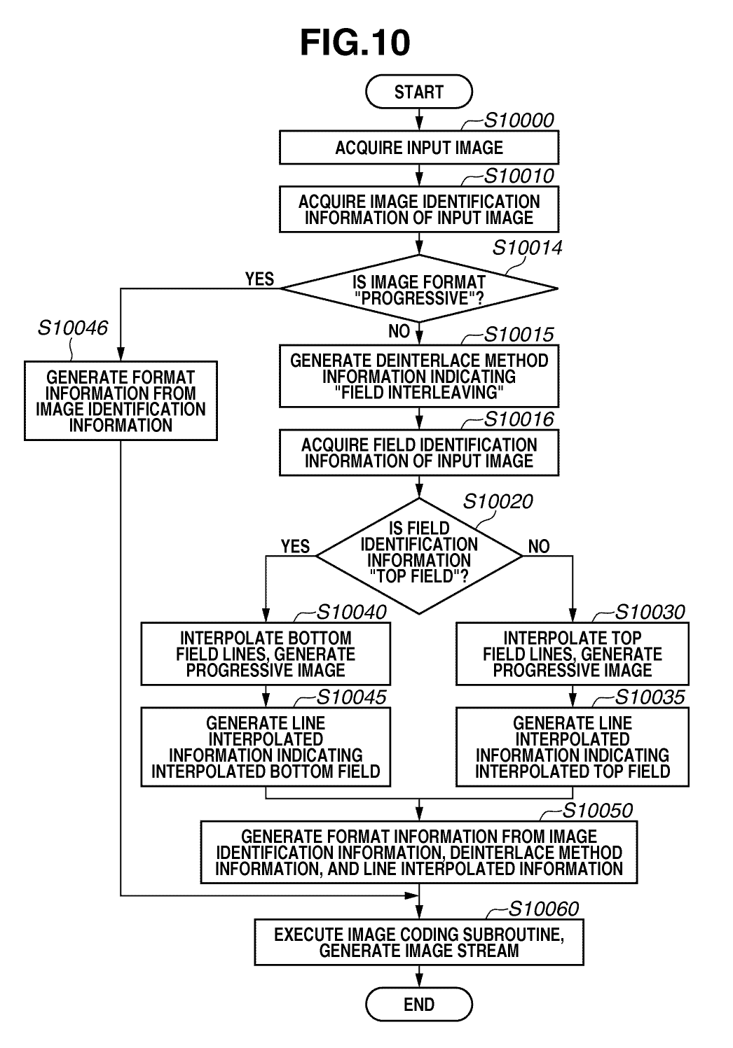

Hereinbelow, operations of the subroutine for performing deinterlace processing and coding processing by the field interleaving method executed in operation S17030 are described with reference to FIG. 10. FIG. 10 is a flowchart illustrating a flow of subroutine for executing deinterlace processing and coding processing by the field interleaving method.

In operation S10000, the CPU 901 acquires an input image. In operation S10010, the CPU 901 acquires image identification information of the input image. In operation S10014, the CPU 901 determines the image format indicated by the image identification information.

When the image identification information indicates the progressive image (YES in operation S10014), the processing proceeds to operation S10046. When the image identification information indicates the interlace image (NO in operation S10014), the processing proceeds to operation S10015. In operation S10015, the CPU 901 generates the deinterlace method information indicating the field interleaving method. In operation S10016, the CPU 901 acquires the field identification information of the input image.

In operation S10020, the CPU 901 determines the field identification information. When the field identification information indicates the bottom field image (NO in operation S10020), the processing proceeds to operation S10030. When the field identification information indicates the top field image (YES in operation S10020), the processing proceeds to operation S10040.

In operation S10030, with respect to the Y-plane of the acquired field image, the CPU 901 acquires an average pixel value of the upper and lower bottom field lines for each pixel, and interpolates all of the pixels positioned on the top field line with the average value thereof, as illustrated in FIG. 5B. In the same manner, the CPU 901 performs the above described processing on the U-plane and the V-plane, and generates the progressive image. In operation S10035, the CPU 901 generates the line interpolated information indicating that the top field lines are interpolated. Thereafter, the processing proceeds to operation S10050.

In operation S10040, with respect to the Y-plane of the acquired field image, the CPU 901 acquires an average pixel value of the upper and lower top field lines for each pixel, and interpolates all of the pixels positioned on the bottom field line with the average value thereof, as illustrated in FIG. 5A. In the same manner, the CPU 901 performs the above described processing on the U-plane and the V-plane, and generates the progressive image. In operation S10045, the CPU 901 generates line interpolated information indicating that the bottom field lines are interpolated. Thereafter, the processing proceeds to operation S10050.

In operation S10046, the CPU 901 generates format information from the image identification information. Then, the processing proceeds to operation S10060. In operation S10050, the CPU 901 generates the format information from the image identification information, the deinterlace method information, and the line interpolated information. Then, the processing proceeds to operation S10060. In operation S10060, the CPU 901 executes an image coding subroutine to generate the image stream. The image coding subroutine will be described below. After performing the processing in S10060, the CPU 901 ends the processing.

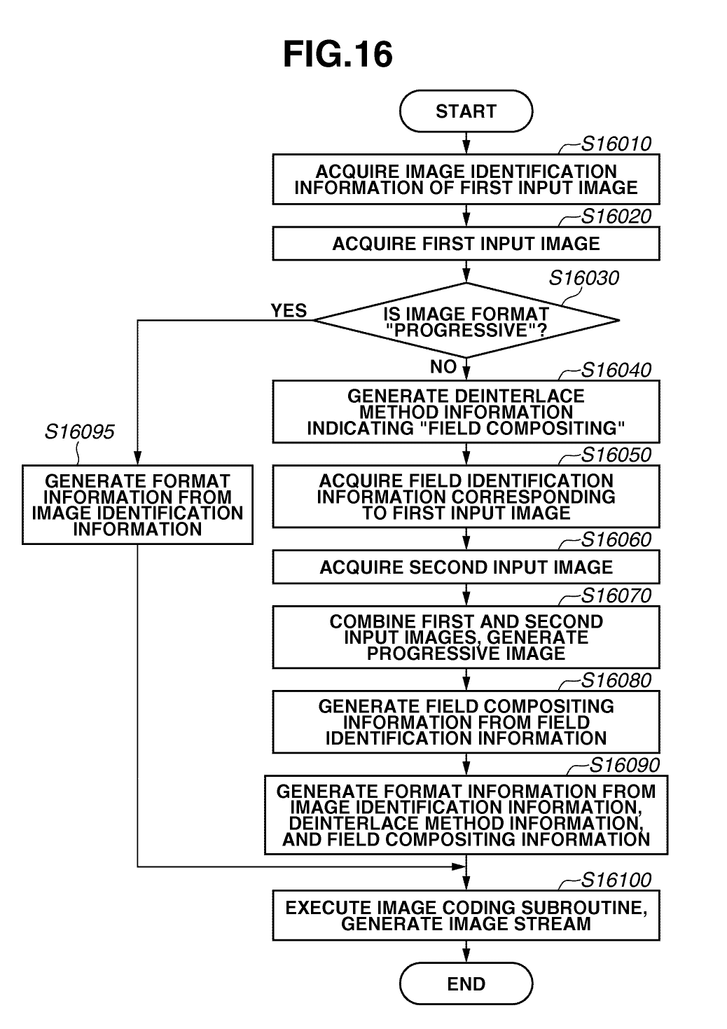

Hereinbelow, operations of the subroutine for performing deinterlace processing and coding processing by the field compositing method are described with reference to FIG. 16. FIG. 16 is a flowchart illustrating a flow of subroutine for performing deinterlace processing and coding processing by the field compositing method.

In operation S16010, the CPU 901 acquires the image identification information of a first input image. In operation S16020, the CPU 901 acquires the first input image. The first input image is a field image if the image identification information indicates the interlace image, whereas the first image is a progressive image if the image identification information indicates the progressive image. In operation S16030, the CPU 901 determines the image format indicated by the image identification information.

When the image identification information indicates the progressive image (YES in operation S16030), the processing proceeds to operation S16095. When the image identification information indicates the interlace image (NO in operation S16030), the processing proceeds to operation S16040. In operation S16040, the CPU 901 generates the deinterlace method information which indicates the field compositing method. In operation S16050, the CPU 901 acquires the field identification information corresponding to the first input image. In operation S16060, the CPU 901 acquires the second input image. The second input image is a field image.

In operation S16070, the CPU 901 generates a progressive image by combining the first input image and the second input image. In the present exemplary embodiment, the interlace image is input in field image units. Therefore, in a case where the first input image is a top field image, the second input image is a bottom field image. On the other hand, in a case where the first input image is a bottom field image, the second input image is a top field image, respectively.

Accordingly, the CPU 901 generates a frame image by interleaving the first input image and the second input image on a line-by-line basis. In the present exemplary embodiment, the CPU 901 generates a progressive image by applying a combing noise reduction filter as the deinterlace method to the frame image.

In the present exemplary embodiment, the deinterlace method which applies the combing noise reduction filter is described. However, the deinterlace method is not limited thereto, and any deinterlace method may be employed as long as the two field images are interleaved to each other.

In operation S16080, the CPU 901 generates the field compositing information from the field identification information. In a case where the field identification information indicates the top field image, since the field identification information corresponds to the first input image, the field compositing information indicates that the top field image temporally precedes the bottom field image. On the other hand, in a case where the field identification information thereof indicates the bottom field image, the field compositing information indicates that the top field image temporally succeeds the bottom field image.

In operation S16090, the CPU 901 generates the format information from the image identification information, the deinterlace method information, and the field compositing information. Then, the processing proceeds to operation S16100. In operation S16095, the CPU 901 generates the format information from the image identification information. After that, the processing proceeds to operation S16100. In operation S16100, the CPU 901 executes the image coding subroutine to generate the image stream.

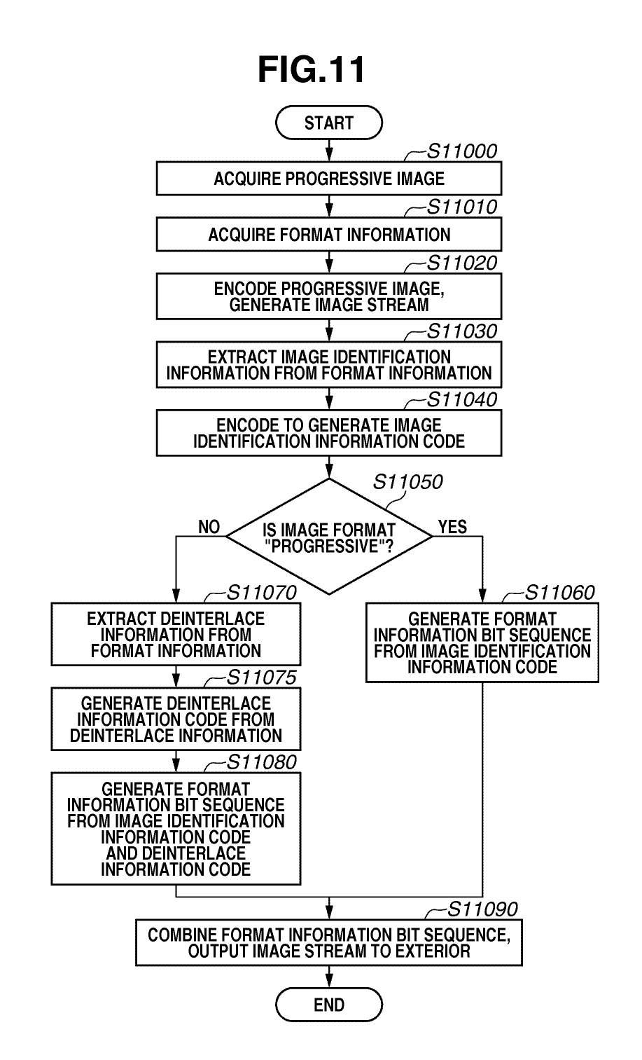

Hereinbelow, an operation of each operation of the image coding subroutine performed in operations S10060 and S16100 is described with reference to FIG. 11. FIG. 11 is a flowchart illustrating a flow of generating and integrating the image stream and the format information bit sequence.

As described in the first exemplary embodiment, the format information bit sequence is generated according to the syntax structure of the format information bit sequence illustrated in FIGS. 6A through 6C.

In operation S11000, the CPU 901 acquires the progressive image. This progressive image is either the image input in operation S10000, or the progressive image generated in any of operations S10030, S10040, and S16070.

In operation S11010, the CPU 901 acquires the format information. This format information is generated in any of operations S10046, S10050, S16095, and S16090. In operation S11020, the CPU 901 performs progressive coding of the progressive image by the H.264 coding method, and generates the image stream.

In the present exemplary embodiment, H.264 is employed as the coding method. However, the coding method is not limited thereto, and other coding method such as MPEG-2 may be employed. Especially, the coding may as well be performed by the coding method such as Motion JPEG 2000 where the interlace coding method is not specified.

In operation S11030, the CPU 901 extracts the image identification information from the format information. In operation S11040, the CPU 901 encodes the image identification information, and generates an image identification information code. In the present exemplary embodiment, a code “original_frame_type” of the syntax illustrated in FIG. 6A is generated as a 2-bit code.

In a case where the image identification information indicates the progressive image, 0 is set as a code value of “original_frame_type”, whereas 1 is set as a code value thereof when the image identification information indicates the interlace image. In operation S11050, the CPU 901 determines the image identification information. When the image identification information indicates the progressive image (YES in operation S11050), the processing proceeds to operation S11060. When the image identification information indicates the interlace image (NO in operation S11050), the processing proceeds to operation S11070.

In operation S11060, the CPU 901 generates the format information bit sequence from the image identification information code. In the present exemplary embodiment, the CPU 901 generates the format information bit sequence only including the code “original_frame_type” in FIG. 6A. The value of the code “original_frame_type” will be described below. Then, the processing proceeds to operation S11090.

In operation S11070, the CPU 901 acquires the deinterlace information from the format information. In operation S11075, the CPU 901 generates the deinterlace information code from the deinterlace information. In the present exemplary embodiment, the CPU 901 generates the deinterlace information code by executing a deinterlace information coding subroutine. The deinterlace information coding subroutine will be described below.

In operation S11080, the CPU 901 generates the format information bit sequence from the image identification information code and the deinterlace information code. In this step, the CPU 901 generates the format information bit sequence including the codes “original_frame_type”, “deinterlace_method”, “top_field_interpolated”, and “top_field_first”.

However, as illustrated in FIG. 6A, the codes “top_field_interporated” and “top_field_first” are included exclusively. The specific value of each code will be described below. Then, the processing proceeds to operation S11090.

In operation S11090, the CPU 901 integrates the format information bit sequence to the image stream, and outputs the image stream to the outside. As illustrated in FIG. 7A, the format information bit sequence is integrated in such a manner that the format information bit sequence is arranged immediately before the image stream. Therefore, the format information bit sequence and the image stream are arranged alternately, thereby forming a series of image streams as the plurality of image streams is generated.

At this time, in order to separate each of the format information bit sequences and the image streams, the CPU 901 applies the start code to each of the leading portions of the format information bit sequence and the image stream. The method for integrating the format information bit sequence and the method for combining the image stream are not limited thereto. For example, the format information bit sequence may be included as apart of header information of the image stream. After performing the processing in S11090, the CPU 901 ends the processing.

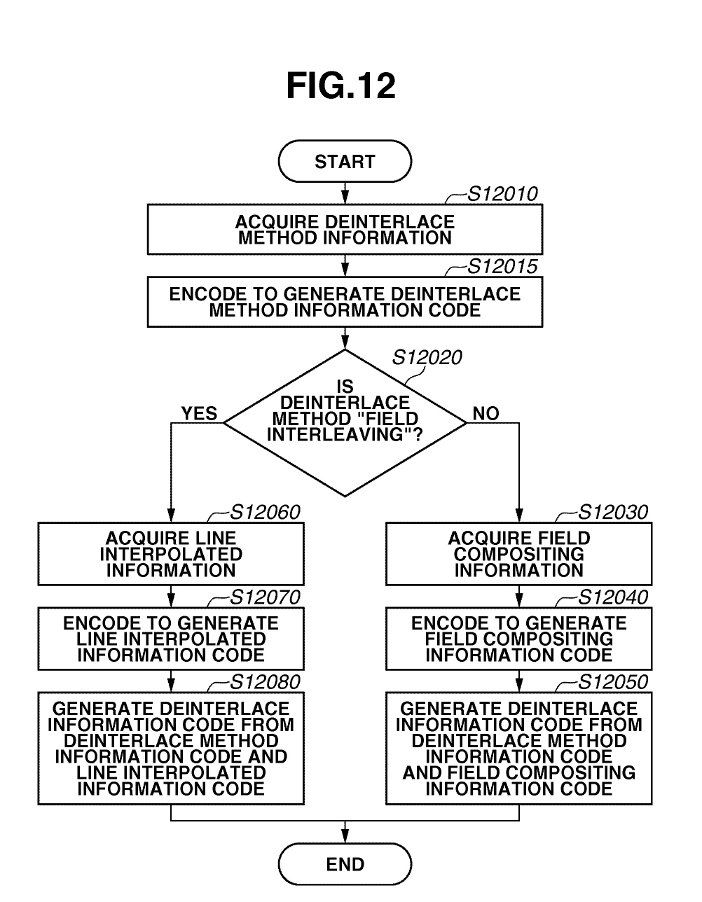

Hereinbelow, operations of the deinterlace information coding subroutine performed in operation S11080 are described with reference to FIG. 12. FIG. 12 is a flowchart illustrating a flow of the deinterlace information coding subroutine.

In operation S12010, the CPU 901 acquires the deinterlace method information. In operation S12015, the CPU 901 encodes the deinterlace method information, and generates the deinterlace method information code.

In the present exemplary embodiment, the CPU 901 generates the code “deinterlace_method” illustrated in FIGS. 6A through 6C as a variable-length Golomb code. When the deinterlace method information indicates the “field interleaving” method, 0 is set as a code value of “deinterlace_method”, whereas 1 is set as a code value thereof when the deinterlace method information indicates the “field compositing” method.

In operation S12020, the CPU 901 determines the deinterlace method. When the deinterlace method information indicates “field compositing” (NO in operation S12020), the processing proceeds to operation S12030. When the deinterlace method information indicates “field interleaving” (YES in operation S12020), the processing proceeds to operation S12060.

In operation S12030, the CPU 901 acquires the field compositing information. In operation S12040, the CPU 901 encodes the field compositing information, and generates a field compositing information code.

In the present exemplary embodiment, the CPU 901 generates the code “top_field_first” illustrated in FIG. 6A through 6C as a 1-bit code. When the field compositing information indicates that “the top field image temporally precedes the bottom field image”, 1 is set as a code value of “top_field_first”, and when the field compositing information indicates that “the top field image temporally succeeds the bottom field image”, 0 is set as a code value thereof.

In operation S12050, the CPU 901 generates a deinterlace information code from the deinterlace method information code and the field compositing information code. After performing the processing in S12050, the CPU 901 ends the processing. In operation S12060, the CPU 901 acquires the line interpolated information. In operation S12070, the CPU 901 encodes the line interpolated information, and generates a line interpolated information code.

In the present exemplary embodiment, the CPU 901 generates the code “top_field_interpolated” illustrated in FIGS. 6A through 6C as a 1-bit code. When the line interpolated information indicates that the top field lines are interpolated, 1 is set as a code value of “top_field_interpolated”, and when the line interpolated information indicates that the bottom field lines are interpolated, 0 is set as a code value thereof. In operation S12080, the CPU 901 generates the deinterlace information code from the deinterlace method information code and the line interpolated information code. After performing the processing in S12080, the CPU 901 ends the processing.

In the present exemplary embodiment, similar to the first exemplary embodiment, the syntax which includes the information of the deinterlace method is defined. Therefore, the CPU 901 generates a format information bit sequence based on the syntax, and integrates this format information bit sequence into the image stream.

The image stream to which the format information bit sequence is integrated is transmitted to the decoding apparatus 802. Through this, the decoding apparatus 802 may receive the information regarding the deinterlace method. In a case where the decoding apparatus 802 outputs the interlace image, the decoding apparatus 802 may reconvert the progressive image that is decoded as the interlace format based on the information relating to the deinterlace method.

In the present exemplary embodiment, the format information bit sequence generated according to the syntax structure illustrated in FIG. 6A is described. However, the format information bit sequence is not limited thereto. Any format information bit sequence may be applicable as long as the format information bit sequence includes a code for the deinterlace method.

For example, a limiting condition, in which the format information bit sequence is integrated to the image stream only when the original image is the interlace image, may be provided. With this limiting condition, it is possible to identify whether the original image is an interlace image even if the format information bit sequence does not include the image identification information code.

Further, in the coding processing and the decoding processing, the deinterlace method may be limited to the field interleaving method only. With this limitation, only the line interpolated information may be transmitted as the information relating to the deinterlace method.

In addition, the coding methods for the respective information codes are not limited to the fixed-length coding and the variable-length coding specified by the syntax. Further, there is no limitation on the order thereof, and an exclusive definition made by the conditional statement is not required if reduction of the code amount is not taken into consideration.

The deinterlace processing according to the present exemplary embodiment is not limited to the above-described processing. For example, the deinterlace processing which interpolates the lines by referring to the other field image, or the deinterlace processing which employs a motion compensation method, may be used as well. Regardless of the change in pixel values of the lines which are originally present in the original image, the deinterlace method is regarded as the “field interleaving” method as long as the frame image is generated by setting a single field image as a reference.

Further, the deinterlace method is regarded as the “field compositing” method as long as the frame image is generated from two filed images.

In the present exemplary embodiment, when the deinterlace processing is performed by the “field interleaving” method, the line interpolated information is encoded and integrated to the image stream. However, the present exemplary embodiment is not limited thereto. Instead, the field identification information of the input field image may be encoded and integrated to the image stream.

The interpolated lines may be obtained if the field image is identified. Accordingly, the same effect may be obtained when either the line interpolated information or the field identification information is encoded and integrated to the image stream.

In the present exemplary embodiment, the configuration in which each of the format information bit sequence and the image stream is stored as independent data separated by the start code has been described. However, the configuration is not limited thereto. For example, the configuration may be such that the syntax illustrated in FIG. 6A is inserted and included as a part of the syntax for the header information of the image stream.

Further, in the present exemplary embodiment, the format information bit sequence is generated and integrated with respect to each of the image streams. However, the configuration is not limited thereto. As illustrated in FIG. 7B, the configuration may be such that the format information bit sequence is only generated with respect to the image stream that is encoded from the first frame, and the format information bit sequence is only integrated to the image stream for the first frame.

FIG. 7B is a diagram illustrating a first modification where the format information bit sequence is only integrated to the image stream of the first frame. In addition, the format information bit sequence may be generated and integrated to the image stream at intervals of a certain number of images.

Further, the configuration may be such that a bit length of the format information bit sequence or a bit length of the image stream is inserted instead of the start code, thereby enabling the boundary position of the data thereof to be identified. In addition, in a case where a plurality of image streams is output as a single file, an index which indicates a position of each of the format information bit sequences and the image streams within the file may be added thereto.

In any of the above described configurations, the boundary between the image streams and the format information bit sequences may be identified.

In the present exemplary embodiment, an image in YUV420 format is described as an example of the color-difference format of the input image. However, the color-difference format is not limited thereto. As an input format, an image in either YUV 422 format or YUV444 format may be input and encoded.

In the present exemplary embodiment, processing in which the interlace image is input and processed in field units is described. However, the processing is not limited thereto. The interlace image may be input in frame units where two field images are combined to form one frame image. In a case where the interlace image is input in frame units, the same processing described in the present exemplary embodiment may be performed by providing a function in which the frame image is separated into two field images, and each of the field images is processed in a sequential manner.

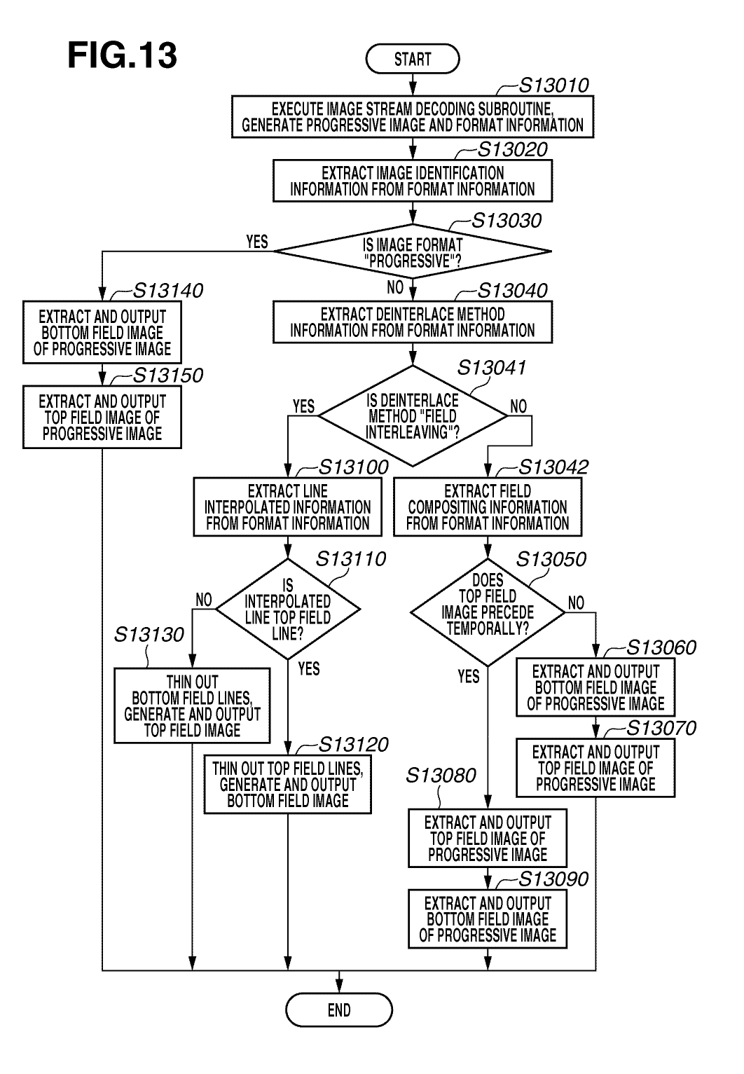

In a fourth exemplary embodiment, a decoding method which decodes an image stream and outputs an interlace image will be described with reference to FIGS. 13, 14, and 15. The image stream is generated by the coding method discussed in the third exemplary embodiment, and a format information bit sequence is integrated thereto. Further, words and terms in the present exemplary embodiment are similar to those discussed in the first exemplary embodiment unless otherwise specified.

In the present exemplary embodiment, the decoding apparatus 802 converts the image that is decoded as a progressive image in YUV 420 frame sequential format into an interlace image in YUV420 frame sequential format. Thereafter, the decoding apparatus 802 outputs the converted interlace image in YUV420 frame sequential format. However, the color-difference format depends on the image stream, and the value thereof is not limited thereto.

FIG. 9 is a block diagram illustrating a hardware configuration for executing a decoding program including a decoding method according to the present exemplary embodiment. The decoding program according to the present exemplary embodiment is stored in the HDD 903. When the decoding program is activated, the decoding program is loaded on the RAM 902. Then, the CPU 901 performs decoding processing by executing each of the following steps.

In the present exemplary embodiment, the image stream that is a decoding target is input from the external storage via the external device I/F 905. Further, the generated image is output to the outside via the network I/F 904, or to the display unit 804 via the graphic output unit 906.

Herein, an operation in each operation of the decoding method according to the present exemplary embodiment is described with reference to FIG. 13. FIG. 13 is a flowchart illustrating a flow of the image decoding processing and the interlace processing. The processing described in FIG. 13 is performed in image units, and a series of video images are decoded by performing the processing in a consecutive manner.

In operation S13010, the CPU 901 executes an image stream decoding subroutine, and generates a progressive image and format information. The image stream decoding subroutine will be described below. In operation S13020, the CPU 901 extracts the image identification information from the format information.

In operation S13030, the CPU 901 determines the image format indicated by the image identification information. When the image identification information indicates the interlace image (No in operation S13030), the processing proceeds to operation S13040. When the image identification information indicates the progressive image (YES in operation S13030), the processing proceeds to operation S13140.

In operation S13040, the CPU 901 extracts the deinterlace method information from the format information. In operation S13041, the CPU 901 refers to the deinterlace method information, and determines the deinterlace method. When the deinterlace method information indicates the field compositing method (NO in operation S13041), the processing proceeds to operation S13042. When the deinterlace method information indicates the field interleaving method (YES in operation S13041), the processing proceeds to operation S13100.

In operation S13042, the CPU 901 extracts the field compositing information from the format information. In operation S13050, the CPU 901 determines whether the field compositing information indicates that “the top field image temporally precedes the bottom field image”. When the field compositing information indicates that “the top field image temporally precedes the bottom field image” (YES in operation S13050), the processing proceeds to operation S13080. When the field compositing information indicates that “the top field image temporally succeeds the bottom field image” (NO in operation S13050), the processing proceeds to operation S13060.

In operation S13060, the CPU 901 extracts and outputs the bottom field image of the progressive image. This interlace processing is performed on each of the Y-plane, the U-plane, and the V-plane. Through the processing performed in operations S13060 and S13070, the CPU 901 separates the combined image from each other, and outputs each of the field images in a correct temporal field order.

In operation S13070, the CPU 901 extracts and outputs the top field image of the progressive image. This interlace processing is performed on each of the Y-plane, the U-plane, and the V-plane. After performing the processing in S13070, the CPU 901 ends the processing.

In operation S13080, the CPU 901 extracts and outputs the top field image of the progressive image. This interlace processing is performed on each of the Y-plane, the U-plane, and the V-plane. Through the processing performed in operations S13080 and S13090, the CPU 901 separates the combined images from each other, and outputs each of the field images in a correct temporal field order.

In operation S13090, the CPU 901 extracts and outputs the bottom field image of the progressive image. This interlace processing is performed on each of the Y-plane, the U-plane, and the V-plane. After performing the processing in S13090, the CPU 901 ends the processing.

In operation S13100, the CPU 901 extracts the line interpolated information from the format information. In operation S13110, the CPU 901 determines the interpolated line identified by the line interpolated information. When the line interpolated information indicates the top field line (YES in operation S13110), the processing proceeds to operation S13120. When the line interpolated information indicates the bottom field line (NO in operation S13110), the processing proceeds to operation S13130.

In operation S13120, the CPU 901 thins out the top field lines of the progressive image. Then, the CPU 901 generates and outputs the bottom field image. The above-described processing is reversed processing of the deinterlace processing described with reference to FIG. 5B, and thus the CPU 901 thins out the pixels other than the pixels of the dark-shaded portions in FIG. 5B. This interlace processing is performed on each of the Y-plane, the U-plane, and the V-plane. After performing the processing in S13120, the CPU 901 ends the processing.

In operation S13130, the CPU 901 thins out the bottom field lines of the progressive image. Then, the CPU 901 generates and outputs the top field image. The above-described processing is a reversed processing of the deinterlace processing described with reference to FIG. 5A, and thus the CPU 901 thins out the pixels other than the pixels of the dark-shaded portions in FIG. 5A. This interlace processing is performed on each of the Y-plane, the U-plane, and the V-plane. After performing the processing in S13130, the CPU 901 ends the processing.

In operation S13140, the CPU 901 extracts the bottom field image of the progressive image. This interlace processing is performed on each of the Y-plane, the U-plane, and the V-plane. Through the processing performed in operations S13140 and S13150, the CPU 901 separates the combined field images from each other, and outputs each of the field images in a correct temporal field order.

In operation S13150, the CPU 901 extracts and outputs the top field image of the progressive image. This interlace processing is performed on each of the Y-plane, the U-plane, and the V-plane. After performing the processing in S13150, the CPU 901 ends the processing.

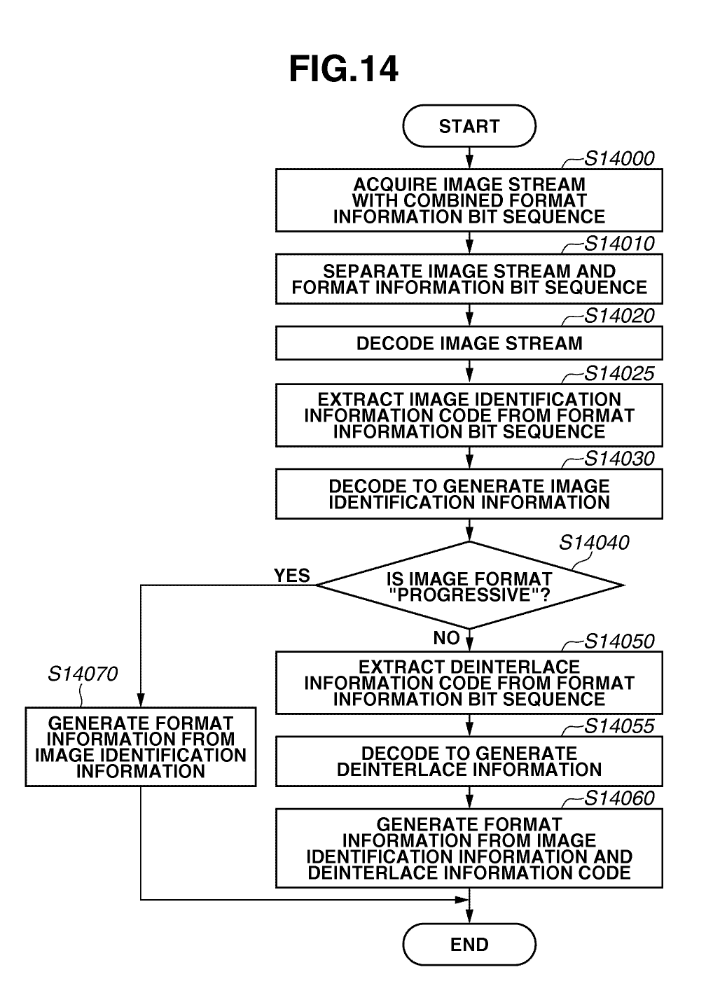

Hereinbelow, a processing flow of the image stream decoding subroutine performed in operation S13010 will be described with reference to FIG. 14. FIG. 14 is a flowchart illustrating a flow of the image stream decoding subroutine.

In operation S14000, the CPU 901 acquires the image stream to which the format information bit sequence is integrated.

At this time, as illustrated in FIG. 7A, the image stream with the integrated format information bit sequence is stored in such a manner that the format information bit sequence is arranged immediately before the image stream. Therefore, the CPU 901 may acquire the format information bit sequence and the image stream in units of a single image by identifying the boundary defined by the start code.

In operation S14010, the CPU 901 separates the image stream and the format information bit sequence. In operation S14020, the CPU 901 decodes the separated image stream as the progressive format by the H.264 method, and generates a decoded image. In the present exemplary embodiment, H.264 is employed as a decoding method. However, the decoding method is not limited thereto, and other decoding methods such as MPEG-2 and Motion JPEG 2000 may be employed as long as the method is the same as that of the coding method employed in the third exemplary embodiment. In operation S14025, the CPU 901 extracts the image identification information code from the format information bit sequence.

In operation S14030, the CPU 901 decodes the image identification information code, and generates the image identification information. In the present exemplary embodiment, the image identification information indicates the progressive image when a decoding value of the code “original_frame_type” of the syntax in FIG. 6A is 0, whereas the image identification information indicates the interlace image when the decoding value thereof is 1.

In operation S14040, the CPU 901 determines the image format indicated by the image identification information. When the image identification information indicates the interlace image (NO in operation S14040), the processing proceeds to operation S14050. When the image identification information indicates the progressive image (YES in operation S14040), the processing proceeds to operation S14070. In operation S14050, the CPU 901 extracts the deinterlace information code from the format information bit sequence.

In operation S14055, the CPU 901 decodes the deinterlace information code, and generates the deinterlace information. In the present exemplary embodiment, the CPU 901 executes a deinterlace information decoding subroutine, and generates the deinterlace information. The deinterlace information decoding subroutine will be described below. In operation S14060, the CPU 901 generates the format information from the image identification information and the deinterlace information.

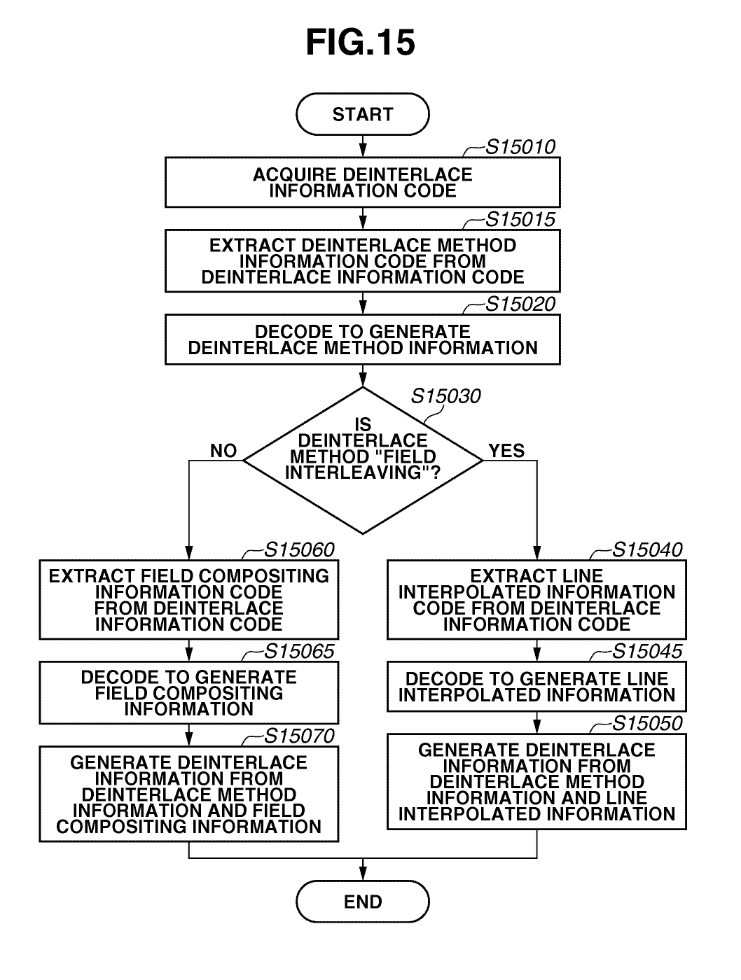

In operation S14070, the CPU 901 generates format information from the image identification information. Hereinbelow, a flow of the deinterlace information decoding subroutine performed in operation S14055 will be described with reference to FIG. 15. FIG. 15 is a flowchart illustrating a flow of the deinterlace information decoding subroutine. In operation S15010, the CPU 901 acquires the deinterlace information code. In operation S15015, the CPU 901 extracts the deinterlace method information code from the deinterlace information code.

In operation S15020, the CPU 901 decodes the deinterlace method information code of the deinterlace information code, and generates the deinterlace method information. In the present exemplary embodiment, the deinterlace method information indicates “field interleaving” when the decoding value of the code “deinterlace_method” is 0, and the deinterlace method information indicates “field compositing” when the decoding value thereof is 1.

In operation S15030, the CPU 901 refers to the deinterlace method information, and determines the deinterlace method. When the deinterlace method information indicates “field interleaving” (YES in operation S15030), the processing proceeds to operation S15040. When the deinterlace method information indicates “field compositing” (NO in operation S15030), the processing proceeds to operation S15060.

In operation S15040, the CPU 901 extracts the line interpolated information code from the deinterlace information code. In operation S15045, the CPU 901 decodes the line interpolated information code, and generates the line interpolated information. In the present exemplary embodiment, the line interpolated information indicates that the bottom field line is interpolated when the decode value of the code “top_field_interpolated” is 0, and the line interpolated information indicates that the top field line is interpolated when the decode value thereof is 1.

In operation S15050, the CPU 901 generates the deinterlace information from the deinterlace method information and the line interpolated information. After performing the processing in S15050, the CPU 901 ends the processing.

In operation S15060, the CPU 901 extracts the field compositing information code from the deinterlace information code. In operation S15065, the CPU 901 decodes the field compositing information code, and generates the field compositing information.

In the present exemplary embodiment, the field compositing information indicates that “the top field image temporally precedes the bottom field line” when the decode value of the code “top_field_first” is 1, and the field compositing information indicates that “the top field image temporally succeeds the bottom field image” when the decode value thereof is 0.

In operation S15070, the CPU 901 generates the deinterlace information from the deinterlace method information and the field compositing information. After performing the processing in S15070, the CPU 901 ends the processing. In a case where the decoding apparatus reconverts the progressive image that has been converted into an interlace image through the line interpolation processing, the decoding apparatus previously could not identify the interpolated lines, and therefore, it was difficult for the decoding apparatus to thin out the interpolated lines in a proper manner.

By employing the configuration according to the present exemplary embodiment, when the decoding apparatus 802 reconverts the progressive image to the interlace image, the decoding apparatus 802 refers to the line interpolated information and thins out the interpolated lines in a correct manner. Through this operation, the decoding apparatus 802 may generate the interlace image that holds the pixels of the original image.

Further, the decoding apparatus 802 may convert the decoded progressive image into the interlace image even in a case where not all of the image streams stored in the external storage are integrated with the format bit sequences, as illustrated in FIG. 7B.

In the example of FIG. 7B, the format information bit sequence is only integrated to an image stream of the first stream. When the deinterlace method is “field interleaving”, the decoding apparatus 802 refers to the line interpolated information to perform interlace processing on the first frame image. Then, the decoding apparatus 802 shifts the thinning-out lines from the lines of the first frame image, and performs interlace processing on the next image which does not hold the line interpolated information. In this manner, the decoding apparatus 802 performs the interlace processing by shifting the thinning-out lines alternately.

When the deinterlace method is “field compositing”, the decoding apparatus 802 performs interlace processing by taking the field compositing information of the first frame and the field compositing information of the second and the subsequent frames as the same. Through this operation, the decoding apparatus 802 generates the field images by correctly thinning out the lines from all of the images.

In addition, even in a case where the format information bit sequence is integrated at intervals of a certain number of frames, the decoding apparatus 802 may perform interlace processing in a same manner as in the case where the format information bit sequence is only integrated to the first frame by setting the image stream to which the format information bit sequence is integrated as a reference point.

In the present exemplary embodiment, the decoding method for outputting the interlace image is described. However, the configuration may be such that the user freely selects and switches the type of output image between the progressive image and the interlace image.

The present exemplary embodiment is configured in such a manner that the decoding apparatus 802 acquires a single image worth of the image stream to which the format information bit sequence is integrated, and separates the format bit sequence and the image stream thereafter. However, the decoding apparatus 802 may acquire the image stream and the format information bit sequence individually. In this case, the processing performed therein is essentially the same as that of the configuration exemplified in the present exemplary embodiment because the processing for separating the format information bit sequence and the image stream, which is performed in operation S14010, is simply performed separately from the flow of processing illustrated in FIG. 14.

Likewise, the decoding apparatus 802 may acquire the code which includes the format information bit sequence individually. Further, in a case where the format information bit sequence is inserted to the image stream as a part of the header information thereof, if a operation for separating the format information bit sequence from the image stream may be provided, the decoding apparatus 802 may perform other processing described in the present exemplary embodiment.

In the present exemplary embodiment, when the CPU 901 converts the progressive image into the interlace image in operations S13140 and S13150, the CPU 901 performs the interlace processing capable of acquiring the same frame rate as that of the progressive image. However, the configuration is not limited thereto. The configuration may be such that the CPU 901 generates the interlace image with an arbitrary frame rate by employing the frame rate conversion processing in combination with the interlace processing.

The exemplary embodiments may be also achieved in the following manner. A storage medium, to which a code of the computer program for realizing the above-described functions is stored, is supplied to a system. Then, the system reads out and executes the code of the computer program. In this case, the code of the computer program itself that has been read out from the storage medium realizes the above-described functions of the exemplary embodiments, and thus, the storage medium to which the code of the computer program is stored configures the exemplary embodiments. Further, the exemplary embodiments also include the case in which an operating system (OS) operating on the computer according to the instructions of the program performs apart or all of the actual processing, thereby realizing the above-described functions through the processing thereof.

Further, the exemplary embodiments may be realized by performing the following processing. A computer program code that is read out from the storage medium is written into a memory provided in a function expansion card inserted into the computer or a function expansion unit connected to the computer. After that, according to the instructions of the code of the computer program, a CPU provided in the function expansion card or the function expansion unit performs a part or all of the actual processing to realize the above-described functions.

In a case where the exemplary embodiments is applied to the above-described storage medium, the code of the computer program corresponding to the above-described flowchart will be stored in the storage medium.

While the disclosure has been described with reference to exemplary embodiments, it is to be understood that the disclosure is not limited to the disclosed exemplary embodiments. The scope of the following claims is to be accorded the broadest interpretation so as to encompass all modifications, equivalent structures, and functions.

This application claims priority from Japanese Patent Application No. 2011-243935 filed Nov. 7, 2011, which is hereby incorporated by reference herein in its entirety.

What is claimed is:

1. An image coding apparatus comprising:
a determination unit configured to determine, from a progressive image and format information indicating characteristics of the progressive image, whether an input progressive image is an image that is deinterlaced from an interlace image;
a deinterlace information extraction unit configured to extract information indicating a deinterlace method from the format information when the input progressive image is a deinterlaced image;
a first coding unit configured to encode a result of the determination unit;
a second coding unit configured to encode a result of the deinterlace information extraction unit;
an image coding unit configured to encode an input progressive image; and
an output unit configured to integrate and output a result of the first coding unit, a result of the second coding unit, and a result of the image coding unit.

2. The image coding apparatus according to claim 1,
wherein the deinterlace information extraction unit extracts information of a field set as a reference of interpolation from the format information.

3. The image coding apparatus according to claim 1,
wherein the deinterlace information extraction unit extracts information indicating a field compositing method from the format information.

4. An image decoding apparatus comprising:
a separation unit configured to separate format information coded data which serves as format information of a coded image, from coded image data;
a first decoding unit configured to decode, from the format information coded data, information indicating whether the coded image is a progressive image or an image that is deinterlaced from an interlace image;
a second decoding unit configured to decode information indicating a deinterlace method when a decoding result of the first decoding unit indicates a deinterlaced image;
an image decoding unit configured to decode the coded image data; and
a format information generation unit configured to generate format information of a decoded image from a result of the first decoding unit and a result of the second decoding unit.

5. An image coding method for an image coding apparatus, comprising:
determining from format information indicating a progressive image and characteristics of the progressive image, whether an input progressive image is an image that is deinterlaced from an interlace image;
extracting information indicating a deinterlace method from format information, when the input progressive image is a deinterlaced image;
encoding the determination result;
encoding the extracted result;
encoding the input progressive image; and
integrating and outputting the coded results and the result of the coded input progressive image.

6. An image decoding method for an image decoding apparatus comprising:
separating format information coded data, which is format information of a coded image, from coded image data;
decoding information, from the format information coded data, indicating whether a coded image is a progressive image or an image deinterlaced from an interlace image;
decoding information indicating a deinterlace method when a result of the decoded information, which indicates whether a coded image is a progressive image or an image deinterlaced from an interlace image, indicates a deinterlaced image;
decoding the coded image data; and
generating format information of the decoded image from the decoding results of the information indicating whether the coded image is a progressive image or an image deinterlaced from an interlace image and the information indicating a deinterlace method.

7. A non-transitory computer-readable recording medium storing a program which causes a computer to function as the image coding apparatus according to claim 1 when the computer reads and executes the program.

8. A non-transitory computer-readable recording medium storing a program which causes a computer to function as the image decoding apparatus according to claim 4 when the computer reads and executes the program.
